(19) United States
(12) Patent Application Publication
(10) Pub. No.: US 2021/0011545 A1
(43) Pub. Date: Jan. 14, 2021

(54) FOLDABLE VIRTUAL REALITY DEVICE

(71) Applicant: Sang Kyu MIN, Seoul (KR)

(72) Inventor: Sang Kyu MIN, Seoul (KR)

(21) Appl. No.: 16/980,009

(22) PCT Filed: Mar. 14, 2019
(86) PCT No.: PCT/KR2019/002971

§ 371 Date: Sep. 11, 2020

(30) Foreign Application Priority Data
Mar. 15, 2018 (KR) 10-2018-0030122

(51) Int. Cl. G06F 3/01; H04M 1/02

(52) U.S. Cl. CPC G06F 3/011; H04M 1/0216

(57) ABSTRACT

A foldable virtual reality device. The device includes: a casing configured to separably accommodate a main body including a display; and a switching body rotatably attached to a side of the casing, switching to come in close contact with a front surface or a rear surface of the main body, and including a screen member and an ocular plate mounted on the screen member, wherein the screen member moves the ocular plate between a state in which the ocular plate is in close contact with the display and a state in which the ocular plate is spaced a predetermined distance from the display, in a state in which the screen member is in close contact with a surface of the main body on which the display is formed, and when the ocular plate is spaced, a virtual reality function can be implemented through the display.

### TECHNICAL FIELD

The present invention is on a virtual reality device, more particularly, on a foldable virtual reality device in the form of a cell phone case in which modules capable of providing virtual reality experience are assembled.

### BACKGROUND ART

Virtual Reality refers to an interface between a human being and a computer that artificially create a certain environment or situation, allowing the user to feel as if they are actually interacting with the surrounding environment or situation. Virtual reality is also referred to artificial reality, cyberspace, virtual worlds, virtual environment, synthetic environment, artificial environment, augmented reality, mixed reality, and more.

The purpose of using virtual reality is to allow people to view and manipulate environment that is hard to experience on a daily basis. Applicable fields are education, remote controlling, remote satellite surface mapping, analysis of exploration data, and scientific visualization.

Recently, due to the widespread of smartphones, virtual reality is regaining attention. For example, there are Gear VR created jointly by SamSung and Occulus, LG's ‘G3 VR’, and Google's ‘cardboard’. These products allow the experience of virtual reality in conjunction with smart phone, and the price is cheaper than the preexisting VR device.

### DISCLOSURE OF THE INVENTION

### Technical Problem

The present invention provides a foldable virtual reality device that is portable and allows a virtual reality or augmented reality to be implemented right at a desired time and place.

More specifically, the present invention provides a cell phone case that includes a virtual reality function.

### Technical Solution

According to an exemplary embodiment of the present invention, a foldable virtual reality device converts to a main body including display and to a rotatable state mounted on a side of the main body adherent to the main body's front or back side. It also includes a screen member and an ocular plate mounted on the screen member, wherein the screen member in close contact with one side of the main body, moves the ocular plate between the state of close contact and the isolated state maintaining a small distance. When the ocular plate is in isolation condition, virtual reality function can be performed through display.

The foldable virtual reality device according to the present invention can include a cell phone function by adding a voice communication module, but can also be connected to the outside via another wired/wireless network without voice communication module, or may include only a virtual reality or augmented reality function. Foldable virtual reality device is portable and can be used as a general cell phone or a handset, that can also perform a virtual reality function regardless of place and time. For example, various operating systems such as Android, Windows, Linux, and OPENELEC can be used as an operating system for the foldable virtual reality device. Even when the foldable virtual reality device is not irrelevant to the virtual reality function, applications such as communication, messaging, multimedia, map, game can be stored and driven. It is also possible to modify and operate the virtual application or the augmented reality while driving a general application.

As the functions that can be implemented by the virtual reality function are increased, the effectiveness of the virtual reality function will also be increased. However, carrying a separate device like the conventional, the needs would not be fully satisfied.

Accordingly, it is an object of the present invention to provide a structure in which a screen member can hold an ocular plate of a variable length from a main body, and at the same time the screen member includes a number of screen boxes which are stacked and fixed to each other while being rearwardly moved, blocking the inflow of external light.

In the present specification, the expression “rearward” or “rear” can be understood as the direction toward the user's face when the foldable virtual reality device is driven.

In the foldable virtual reality device, the screen member can switch the ocular plate into a close contact state and a separated state through methods such as volume reduction, enlargement, fixation, movement, separation and folding. In order to facilitate portability, the screen member can be maintained in reduced, folded or fixed state.

In addition, although the screen member can be operated manually, it can also be operated through electric signals, and by a power transmission device.

The virtual reality function using the display of the main body and the ocular plate in the separated state can be implemented in various ways. For example, a stereoscopic effect can be performed by dividing a virtual reality display into left and right and using a pair of ocular lenses as in a conventional card board, but it is also possible to divide and display an image up and down according to a virtual reality system. In addition, polarizing glasses for mounting a polarizing lens on an ocular plate or a shutter glass for opening and closing left and right ocular lenses on an ocular plate with a time difference can be applied to the present invention. In addition to virtual reality implementation or stereoscopic display, various combinations of display and lens combinations can be implemented.

While not using the virtual reality feature, it is necessary that the ocular plate maintain close contact with the main body, and while using the virtual reality function, it should be separated by the main body, maintaining the predetermined distance. For this purpose, the ocular plate should be able to form a variable distance rather than being fixed to the main body. To this end, the screen member can move the ocular plate between the attached and detached states in a variety of ways.

For example, the screen member can be embodied as plural screen box, and the mutual frictional and clamping forces of the screen boxes can be utilized to maintain the spacing between the display and the contact plate of the inverted main body, blocking the outer light. Alternatively, a screen member may be interposed between the main body and the ocular plate moving the ocular plate between the close contact state and the separated state and can also additionally provide a shield for blocking the inflow of external light.

When the screen member is performed as a screen box, the screen box may be formed as a single wall structure, but it can also be provided with a double wall structure for a solid support and light weight. That is, for the double wall structure, the screen box may include an inner wall and an outer wall, with a minimum space formed in between.

In addition, in order to solve heat and electromagnetic waves generated from the virtual reality display, ventilation holes may be formed in the screen box. However, since light can directly enter from the outside through the ventilation hole, a first ventilation hole is formed in the inner wall of the screen box of the double wall structure, and a second ventilation hole is formed in the outer wall. Thus, the first ventilation hole and the second ventilation hole do not overlap, in other words are dislocated in order to prevent light from directly entering from the outside.

Since the screen member only serves the purpose of effectively blocking external light, it is also possible to partially open while not distracting its original function in addition to completely blocking the main body and the ocular plate.

In order to more realistically perform the virtual reality function, the virtual reality device may further include a fixing member capable of fixing the virtual reality device to the user's face. The fastening member may be provided in various forms such as an earring form of a conventional mask, a hook portion of a spectacle, a helmet mount or an elastic band.

The switching body is rotatable on either side of the long side and the short side of the main body. The switching body can be closely attached to the display while rotating around one side of the main body according to the user's need, and the virtual reality function can be performed while expanding the ocular plate in a separated state.

In the present embodiment, the “display” may be one of the displays mounted on the main body, or may be a display installed in front of the main body, and may be added to the virtual reality or augmented reality.

According to an exemplary embodiment of the present invention, a foldable virtual reality device includes a main body including a display and guide rails formed side by side; and a switching body which is slidably mounted on a guide rail of the main body and is switched into a state of close contact with a front surface and a rear surface of the main body. The screen member and a tilting plate mounted on the screen member, moves the ocular plate between an adhering state in which the ocular plate is closely attached to the display and a detached state in which the ocular plate maintains a predetermined distance. In a state in which the ocular plate is detached to the surface of the main body, the virtual reality function can be performed through the display.

The guide rail may be formed along a long side surface or a short side surface of the main body, and the changeover body may be detached from the main body and then converted to the front or rear surface of the main body and reinstalled in the main body.

According to an exemplary embodiment of the present invention, a foldable virtual reality device includes: a main body including a display; and a switching body which is switched to a state of being in close contact with the front and rear surfaces of the main body, and a screen member and a ocular plate mounted on the screen member, wherein the switching body is slidable and rotatable with respect to the main body. The main body of the display can be switched between the front face and the back face of the main body and the screen body can be switched between a close state in which the contact plate is in close contact with the display, moving the ocular plate between states and when the ocular plate is in a separated state, performs the virtual reality function through display.

The foldable virtual reality device may further include a rail body rotatably mounted on the main body and coupling the switching body to allow sliding movement, and the rail body may be mounted on the long side or the short side of the main body.

According to an exemplary embodiment of the present invention, a collapsible virtual reality device comprises: a main body including a display; and a switching body which is detached and attached to the front and back surfaces of the main body, and a screen member and an ocular plate mounted on the screen member. The ocular plate is moved between a close contact state in which the ocular plate is closely attached to the display and a separate state in which a predetermined distance is maintained, and when the ocular plate is in a detached state, a virtual reality function can be performed through the display.

The switching body can use at least one from the detachable button, magnet button, coupling projection-groove structure, or a suction plate to be detachably attached to the main body.

The ventilation hole can be formed in the screen member, but the ventilation hole can also be formed in the ocular plate.

According to an exemplary embodiment of the present invention, a foldable virtual reality device includes a main body including a virtual reality display; an ocular plate capable of maintaining a variable distance from the main body and incorporating a battery for operating the main body; and a screen member interposed between the main body and the ocular plate and moving the ocular plate between the main body and the ocular plate, wherein the ocular plate is in close contact with the ocular plate; and when the ocular plate is in a separated state, a virtual reality function can be performed through the display of the main body.

Here, the ocular plate may further include at least one from camera, a main board, and an antenna for a foldable virtual reality device, and may include a fixing member for temporarily fixing the foldable virtual reality device to the user's face.

In the present specification, the expression “rearward” or “rear” can be understood as the direction toward the user's face when the foldable virtual reality device is driven.

### Advantageous Effects

The foldable virtual reality device according to the present invention can be utilized as a portable device by combining the virtual reality module with a portable structure so that the virtual reality function can be performed regardless of the place and time. As the functions that can be performed by the virtual reality function increase, and the convenience of the user is also expected to improve.

In addition, when the main body is mounted reversibly, it is possible to use the device both as a general monitor and a virtual reality monitor in one display.

In addition, it is possible to form a structure in which the ocular plate can be maintained at a variable length from the main body by the screen member, and the light blocking screen function for blocking the inflow of external light by the same structure can be implemented at the same time, allowing high-quality slide movement and robustness to be obtained at the same time.

The effectiveness of this characteristic will double by forming the screen barrel into a double wall, and the user convenience will be further increased through the formation of the deflected air vents and the lightweight.

### BRIEF DESCRIPTION OF THE FIGURES

FIG. 1 is a perspective view illustrating a foldable virtual reality device according to an embodiment of the present invention.

FIG. 2 is a side view for explaining the switching process of the foldable virtual reality device of FIG. 1.

FIG. 3 is a side view for explaining the expansion state of the foldable virtual reality device of FIG. 1.

FIG. 4 is a perspective view for explaining a foldable virtual reality device according to an embodiment of the present invention.

FIG. 5 is a side view for explaining the switching process of the foldable virtual reality device of FIG. 4.

FIG. 6 is a side view for explaining an expanded state of the foldable virtual reality device of FIG. 4.

FIG. 7 is a perspective view for explaining a foldable virtual reality device according to an embodiment of the present invention.

FIG. 8 is a side view for explaining the switching process of the foldable virtual reality device of FIG. 7.

FIG. 9 is a side view for explaining an expanded state of the foldable virtual reality device of FIG. 7.

FIG. 10 is a view illustrating the structure of Deep Neural Networks (DNN).

FIG. 11 is a view illustrating the structure of Convolutional Deep Neural Networks (CNN).

FIG. 12 is a view illustrating a process of calculating a product.

FIG. 13 is a view illustrating a sub-sampling process.

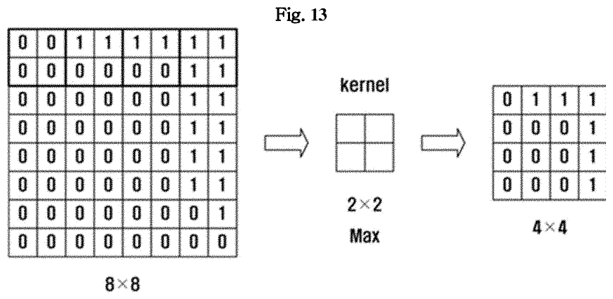

FIG. 14 is a view illustrating a drone and a protective case according to an embodiment.

FIG. 15 is a view for explaining a method of compositing an object and a background according to an embodiment.

FIG. 16 is a view showing a virtual reality device and a helmet-type device combined with the virtual reality device.

FIG. 17 is a view showing a virtual reality device including a brain wave module according to an embodiment.

FIG. 18 is a view showing an artificial intelligence bed according to an embodiment.

FIG. 19 is a view showing a virtual reality device with built-in earphones according to an embodiment.

FIG. 20 is a view showing a virtual reality experience shoe according to an embodiment.

FIG. 21 is a view showing a virtual reality experience golf club according to an embodiment.

FIG. 22 is a view showing a virtual reality device including one or more movable cameras in accordance with an embodiment.

FIG. 23 is a view showing an antenna selfie stick according to an embodiment.

FIG. 24 is a view showing a virtual reality device according to an embodiment.

### BEST MODE

A foldable virtual reality device comprises: a casing configured to separably accommodate a main body including a display; and a switching body rotatably attached to a side of the casing, switching to come in close contact with a front surface or a rear surface of the main body, and including a screen member and an ocular plate mounted on the screen member, wherein the screen member moves the ocular plate between a state in which the ocular plate is in close contact with the display and a state in which the ocular plate is spaced a predetermined distance from the display, in a state in which the screen member is in close contact with a surface of the main body on which the display is formed, and when the ocular plate is spaced, a virtual reality function can be implemented through the display.

A foldable virtual reality device comprises: a switching body slidably mounted on guide rails of a main body that includes a display and the rail guide formed in parallel along a side, switching to come in close contact with a front surface and a rear surface of the main body, and including a screen member and an ocular plate mounted on the screen member, wherein the screen member moves the ocular plate between a state in which the ocular plate is in close contact with the display and a state in which the ocular plate is spaced a predetermined distance from the display, in a state in which the screen member is in close contact with a surface of the main body on which the display is formed, and when the ocular plate is spaced, a virtual reality function can be implemented through the display.

A foldable virtual reality device comprises: a switching body switching to come in close contact with a front surface and a rear surface of a main body that includes a display, and including an ocular plate mounted on the screen member, wherein the switching body can slide and rotate with respect to the main body, thereby being able to switch between the front surface and the rear surface of the main body, the screen member moves the ocular plate between a state in which the ocular plate is in close contact with the display and a state in which the ocular plate is spaced a predetermined distance from the display, in a state in which the screen member is in close contact with a surface of the main body on which the display is formed, and when the ocular plate is spaced, a virtual reality function can be implemented through the display.

### Mode

Hereinafter, preferred embodiments of the present invention will be described in detail with reference to the accompanying drawings, but the present invention is not limited to or limited by the embodiments. Note that, in this description, the same numbers refer to substantially the same elements and can be described with reference to the contents described in the other drawings under such a rule, and contents which are judged to be obvious to the persons skilled in the art or repeated may be omitted.

The terminology used herein is for the purpose of describing the embodiments and is not intended to be limiting of the invention. In the present specification, the singular form includes plural forms unless otherwise specified in the specification. “comprises” and/or “comprising” used in the specification do not exclude the presence or addition of one or more other elements in addition to the stated element. Like reference numerals refer to like elements throughout the specification and “and/or” include each and every combination of one or more of the elements mentioned. Although “first”, “second”, and the like are used to describe various components, these components are not limited by these terms, of course. These terms are used only to distinguish one component from another. Therefore, it goes without saying that the first component mentioned below may be the second component within the technical scope of the present invention.

Unless defined otherwise, all terms (including technical and scientific terms) used herein may be used in a sense that is commonly understood by one of ordinary skill in the art to which this invention belongs. In addition, commonly used predefined terms are not ideally or excessively interpreted unless explicitly defined otherwise.

As used herein, the term “part” or “module” refers to a hardware component such as software, FPGA, or ASIC, and the “component” or “module” performs certain roles. However, “part” or “module” is not meant to be limited to software or hardware. A “part” or “module” may be configured to reside on an addressable storage medium and configured to play back one or more processors. Thus, by way of example, “a part” or “module” refers to components such as software components, object-oriented software components, class components and task components, and processes, Microcode, circuitry, data, databases, data structures, tables, arrays, and variables, as used herein.

The terms spatially relative, “below”, “beneath”, “lower”, “above”, “upper” May be used to easily describe a correlation between one component and other components as described above. Spatially relative terms should be understood in terms of the directions shown in the drawings, including the different directions of components at the time of use or operation. For example, when inverting an element shown in the Figures, an element described as “below” or “beneath” of another element may be placed “above” another element. Thus, the exemplary term “below” can include both downward and upward directions. The components can also be oriented in different directions, so that spatially relative terms can be interpreted according to orientation.

In this specification, the virtual reality and the virtual reality video are not limited to the VR (Virtual Reality) and the VR video but may be a virtual reality (VR), a virtual reality video, an Augmented Reality (MR), Mixed Reality and Mixed Reality video, and also includes all kinds of videos including real, virtual, real, and virtual images, including but not limited to, augmented reality images and mixed reality do.

Embodiments of the method of utilizing the virtual reality device disclosed herein may also be applied to various types of virtual reality devices such as Virtual Reality (VR), Augmented Reality (AR), Mixed Reality (MR) It will be understood by those of ordinary skill in the art that the present invention can be applied to all.

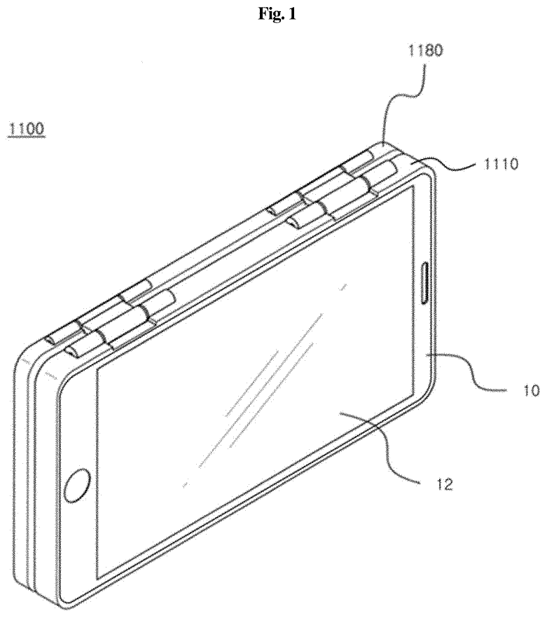

Hereinafter, a first embodiment of a foldable virtual reality device will be described with reference to FIGS. 1 to 9.

In the disclosed embodiment, the foldable virtual reality device may be configured in the form of a case capable of receiving (or releasably coupling) the display device. For example, the foldable virtual reality device can be configured in the form of a cell phone case that accommodates a cell phone (e.g., a smart phone) and can view a virtual reality image using a screen of the cell phone.

In another embodiment, the foldable virtual reality device may be provided with a display device (for example, a smart phone) integrally.

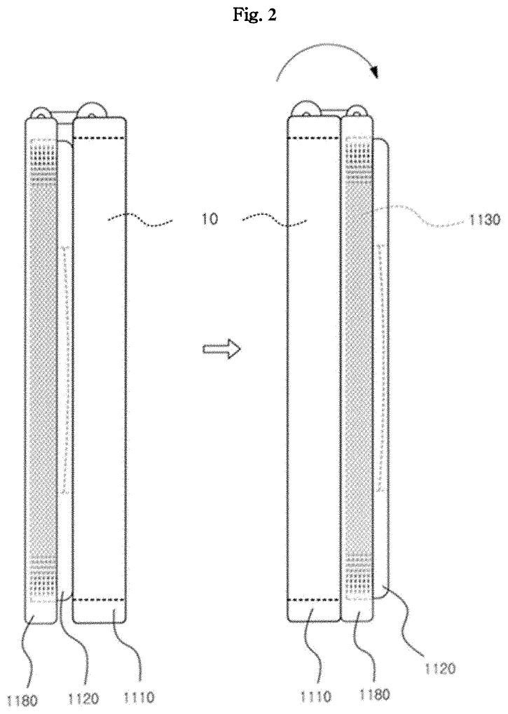

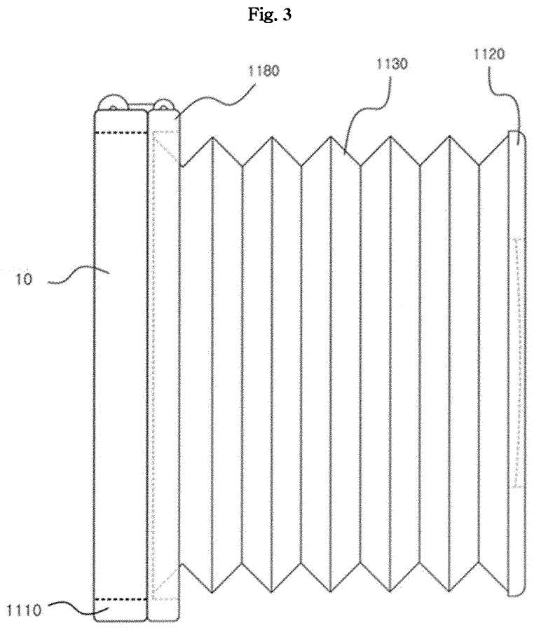

FIG. 1 is a perspective view for explaining a foldable virtual reality device according to an embodiment of the present invention, FIG. 2 is a side view for explaining a conversion process of the foldable virtual reality device of FIG. 1, FIG. 3 is a side view for explaining the expansion state of the foldable virtual reality device of FIG. 1.

Referring to FIGS. 1 to 3, the foldable virtual reality device according to the present embodiment includes a casing 1110 that accommodates a cell phone 10 including a display 12, and a casing 1110 that is provided on one side of the casing 1110 and a changeover body 1180 that is mounted so that it can rotate. The switching body 1180 rotates at one side of the casing 1110 to be in tight contact with the front and back surfaces and includes a screen member 1130 and an ocular plate 1120 mounted on the screen member 1130.

In another embodiment according to FIGS. 1 to 3, the foldable virtual reality device comprises a cell phone 10 including a display 12 and a switching body 1180 mounted on one side of the cell phone so that it can rotate. The switching body 1180 is rotated on one side of the cell phone 10 and is in a state of close contact with the front and back surfaces and may include a screen member 1130 and an ocular plate 1120 mounted on the screen member 1130.

As shown in FIG. 1, the switch body 1180 can move to the back and front of the casing 1110 using a multi-axis hinge or a single-axis hinge. The display 12 of the cell phone 10 accommodated in the casing 1110 can display an image or a user interface for multimedia when the switching body 1180 remains in close contact with the rear surface of the casing 1110 and when a communication module is mounted on the casing 1110 or the switching body 1180, it can also function as a communication device.

Then, when the switching body 1180 is brought into close contact with the front surface of the casing 1110 the ocular plate 1120 can be extended in a spaced apart state as shown in FIG. 2, and the screen member 1130 can also be expanded in the form of a bellows, or the like. Apart from this, it may also be provided to be compressed or elongated using a plurality of screen barrels, as described in the previous embodiments.

Although not shown, the screen member 1130 can maintain a detached state, in which case the link members shown may be used, and a hydraulic cylinder, various types of actuators such as a pneumatic cylinder, an antenna lever, a solenoid, a coil spring, and a shape-based alloy can be used, and such a spacing device or a distance adjusting portion can be mounted outside or inside the screen member 1130.

In a state in which the screen member 1130 is in close contact with the front surface of the casing 1110 (that is, in a state of being in tight contact with the front surface of the cell phone 10 accommodated in the casing 1110, the ocular plate 1120, and the screen member can be extended to a detached state. Moreover, as described above, the virtual reality function can be implemented through the display 12 when the ocular plate 1120 is in a detached state.

In the present embodiment, the switching body 1180 rotates at the longitudinal side of the casing 1110, but the switching body 1180 can be mounted to rotate at the opposite longitudinal side of the casing 1110, and it can also be mounted to rotate at the non-end side.

The technical features described in this embodiment are applicable to other embodiments, and those skilled in the art will be able to modify the embodiments in accordance with the ordinary inventive skill.

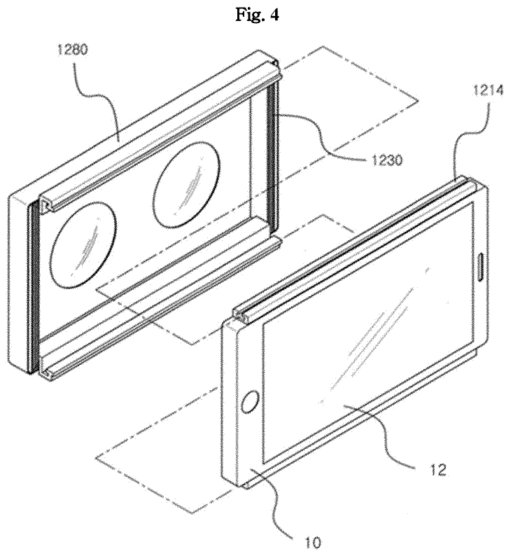

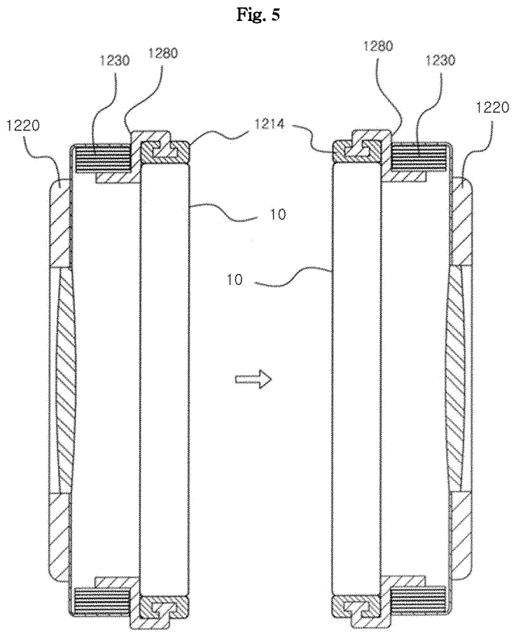

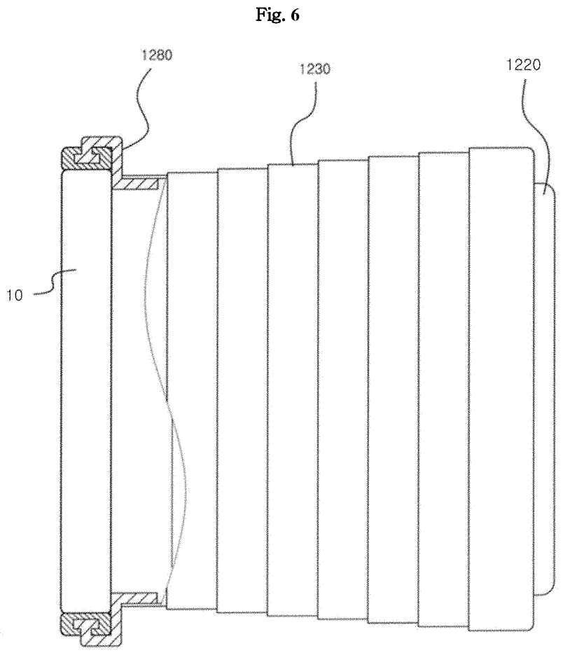

FIG. 4 is a perspective view for explaining a foldable virtual reality device according to an embodiment of the present invention, FIG. 5 is a side view for explaining a switching process of the foldable virtual reality device of FIG. 4, FIG. 6 is a side view for explaining the expansion state of the foldable virtual reality device of FIG. 4.

Referring to FIGS. 4 to 6, the foldable virtual reality device according to the present embodiment includes a guide rail 1214 which is attached or detachably attached to a side face of a cell phone 10 including a display 12, and a switch body 1280 mounted on the rail 1214 so that it can slide. In one embodiment, the guide rail 1214 may be provided on one side of a casing (not shown) that can receive the cell phone 10.

In one embodiment, the cell phone 10 may be provided with a guide rail 1214 coupled to the side thereof as an integral part thereof.

The switching body 1280 can be detached or mounted while sliding along the guide rail 1214, and the guide rail 1214 can also be formed in a back-and-forth symmetrical manner so as to be brought into close contact with the front surface and the rear surface. The switch body 1280 may include a screen member 1230 and an ocular plate 1220 mounted to the screen member 1230.

As shown in FIG. 5, the switching body 1280 can be moved to the back face and the front face of the cell phone 10 with the front and rear directions different in the guide rail 1214. The display 12 of the cell phone 10 may display an image or a user interface for multimedia and the cell phone 10 may display the video or user interface for the multimedia, or when the communication module is mounted on the switching body 1280, it can also function as a communication device.

As shown in FIG. 6, the ocular plate 1220 can be extended in a spaced apart state, and the screen member 1230 can also be expanded using a plurality of screen barrels.

Although not shown, the screen member 1230 can maintain a spacing state by using its own frictional force, and besides, a hydraulic cylinder, a pneumatic cylinder, an antenna lever, a solenoid, a coil spring, a shape, and a distance adjusting unit can be mounted on the outside or the inside of the screen member 1230.

In a state in which the screen member 1230 is in close contact with the front face of the cell phone 10 on which the display 12 is formed, the ocular plate 1220 and the screen member 1230 can be extended in a spaced apart state. Furthermore, as described above, the virtual reality function can be implemented through the display 12 when the ocular plate 1220 is in a detached state.

In the present embodiment, the switching body 1280 is detachably attached along the guide rail 1214 formed on the long side of the cell phone 10, but the switching body 1280 forms the short side guide rail rather than the long side, and can be detached and attached while moving in a direction parallel to the side surface.

The technical features described in this embodiment are applicable to other embodiments, and those skilled in the art will be able to modify the invention in accordance with other embodiments by using ordinary creative ability.

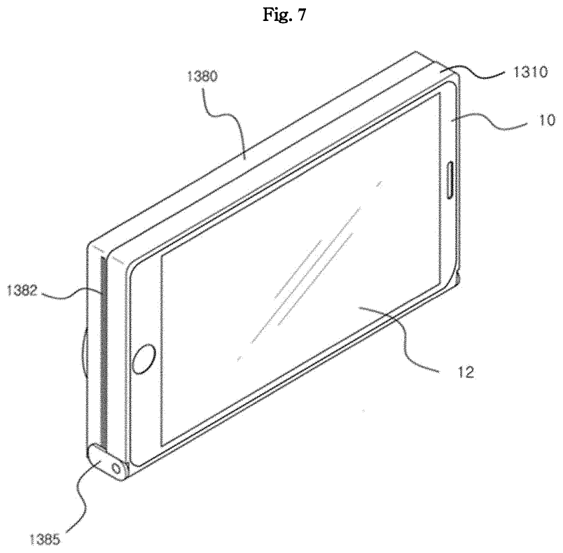

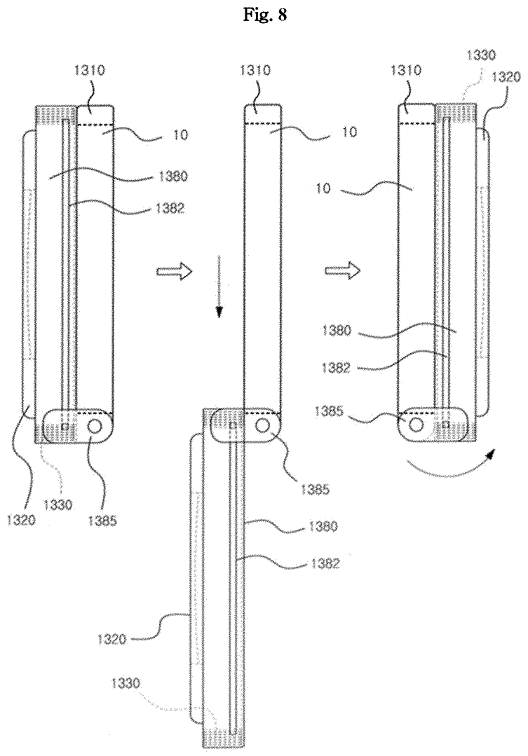

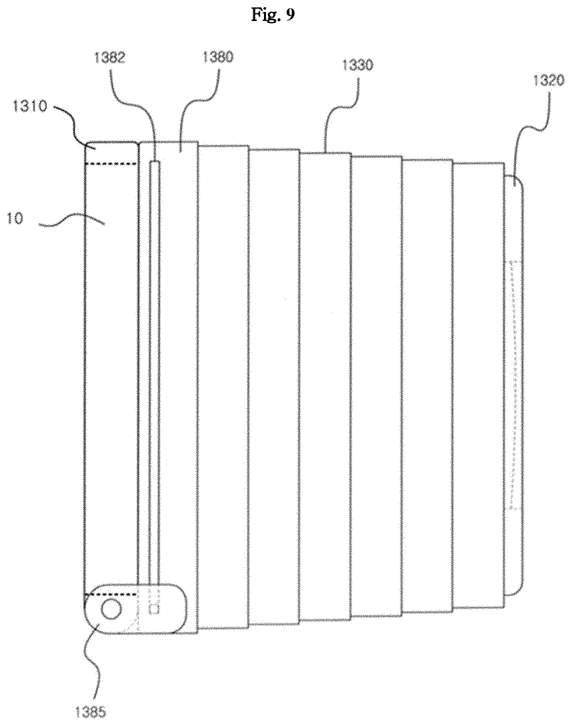

FIG. 7 is a perspective view for explaining a foldable virtual reality device according to an embodiment of the present invention, FIG. 8 is a side view for explaining a switching process of the foldable virtual reality device of FIG. 7, FIG. 9 is a side view for explaining the expansion state of the foldable virtual reality device of FIG. 7.

In FIGS. 7 to 9, the foldable virtual reality device according to the present embodiment includes a casing 1310 for accommodating a cell phone 10 including a display 12, and a switching body 1380 for sliding and rotating of the casing 1310. The switching body 1380 may include a screen member 1330 and an ocular plate 1320 attached to the screen member 1330.

In another embodiment according to FIGS. 7 to 9, the foldable virtual reality device is mounted on the cell phone 10 including the display 12 and the cell phone 10 so as to be able to slide and rotate and a switching body 1380. The switching body 1380 may also include a screen member 1330 and an ocular plate 1320 mounted to the screen member 1330.

The casing 1310 and the switching body 1380 are interconnected via a rail body 1385. Specifically, the rail body 1385 is mounted on one side of the casing 1310 so that it can rotate and is connected to the switching body 1380 via a rail 1382 so that it can slide. Accordingly, the switching body 1380 is capable of sliding and rotating relative to the casing 1310 and can be switched between the front and back surfaces of the main body 1380.

As shown in FIG. 8, the switching body 1380 can slide along the rail body 1385 and is rotatable with the rail body 1385. Therefore, it is possible to move to the back face and the front face of the cell phone 10 accommodated in the casing 1310 and the casing 1310 by varying the forward and backward directions through the slide movement and the rotation movement. The display 12 of the cell phone 10 housed in the casing 1310 is rotated in the vertical direction when the switching body 1380 is kept in close contact with the back surface of the cell phone 10 accommodated in the casing 1310 and the casing 1310. And it may function as a communication device when a communication module is mounted in the casing 1310 or the switching body 1380.

Then as shown in FIG. 9, when the switching body 1380 is kept in close contact with the front surface of the cell phone 10 accommodated in the casing 1310 and the casing 1310, the ocular plate 1320 and the screen member 1330 can be expanded using a plurality of screen barrels.

Although not shown, the screen member 1330 can maintain a detached state by using its own frictional force and can be used as a spacing device or a distance adjusting portion, such as a hydraulic cylinder, a pneumatic cylinder, an antenna lever, a solenoid, or the like may be used. The detaching device or the distance adjusting portion may be mounted on the outside or the inside of the screen member 1330.

In a state in which the screen member 1330 is in close contact with the front face of the cell phone 10 accommodated in the casing 1310 and the casing 1310, the ocular plate 1320 and the screen member 1330 are extended. Moreover, as described above, the virtual reality function can be performed through the display 12 when the ocular plate 1320 is in a detached state.

In the present embodiment, the switching body 1380 is switched by the rail body 1385 mounted on the longitudinal side of the main body 1310, but the switching body 1380 is provided with the rail. It is also possible to form a body or other structure, and to switch the position on the short side.

Hereafter, various embodiments that can use the virtual reality device according to the disclosed embodiment are described in detail.

As described above, in the embodiments to be described hereafter, a virtual reality device is used as a meaning that includes all of a computing device including at least one or more processors and a display, a device for watching a virtual reality video displayed through a display, a device formed by integrating a computing device and a device for watching a virtual reality video, various types of devices, such as a case accommodating a computing device, a cell phone case covering a cell phone, or a case including at least one display, in which a device for watching a virtual reality video is disposed in a separate case, and combinations of these devices.

For example, the methods of using the virtual reality device are performed by at least one of at least one sensor that is included in a computing device or a case accommodating a computing device, an application that is executed by at least one processor included in a computing device or a case accommodating a computing device, and an application that is executed by a server connected to the virtual reality device.

In detail, some or all of the operations to be described below may be performed by a virtual reality device, a mobile terminal, a case including a mobile terminal, all kinds of computing device including a server and peripherals thereof, and combinations of these devices.

Specific operations described in embodiments of the present disclosure are embodiments without limiting the range of embodiments in any way. For briefness of the specification, electronic components, control systems, and software of the related art, and other functions of the systems may not be described. Furthermore, wire connection and connecting members of components shown in the figures are examples of functional connection and/or physical or circuit connections, and in actual devices, they may be replaceable or may be shown as various additional functional connection, physical connection, or circuit connection. Further, unless specifically stated such as “necessary”, “importantly”, etc., the components may not be necessary parts for applying the present disclosure.

The term “the” and indicators similar to the term that are used in the specification (particularly, claims) may be applied to both singular and plural terms. Further, when a range is stated in an embodiment, it includes cases in which individual values included in the range are applied (unless there is opposed description), which means that the individual value in the range are described in the specification. Finally, unless the order of steps constituting a method according to an embodiment is definitely described or there is opposed description, the steps may be performed in appropriate order. Embodiments are not necessarily limited to the stated order of the steps. In embodiments, all examples or exemplary terms (e.g., etc.) are simply used to describe the embodiments in detail, and the range of the embodiments is not limited by the examples or exemplary terms unless limited by claims. It would be understood by those skilled in the art that the present disclosure may be configured in accordance with design conditions and factors within claims having various changes, combinations, and modifications or an equivalent range.

Various embodiments described herein may be recombined and rearranged, and the combinations should be understood as being included in the range of the present disclosure as long as the configurations described herein, other than the combinations, can be easily combined by those skilled in the art on the basis of the description and drawings provided herein.

Throughout the specification, when a component is “connected” to another component, it includes not only “direct connection”, but also “indirect connection” with another element interposed therebetween. Similarly, when a component can transmit/receive a predetermined signal to/from another component in a wire or wireless ways, they may be understood as being connected to each other.

In this specification, the virtual reality and the virtual reality video are not limited to the Virtual Reality (VR) and the VR video but includes all of a virtual reality (VR), a virtual reality video, an Augmented Reality (AR), an AR video, Mixed Reality (MR), and an MR video, and also includes all kinds of videos including reality, virtual reality, and a mixture of reality and virtual reality without being limited thereto.

Further, a virtual reality device described hereafter or a server connected with the virtual reality device learn and operate using artificial intelligence, and a learning method to be described below may be applied to each embodiment. However, this is provided as an example and learning methods that are applied or applicable to the disclosed embodiments are not limited to the following description.

An Artificial Intelligence (AI) system is a computer system that implements intelligence of or over human and is a system in which machines learn, determine, and get smart by themselves unlike the existing rule-based smart system. Artificial intelligence systems are improved in recognition ratio and can more accurately understand the users' tastes as they are used, so the existing rule-based smart systems are gradually replaced by a deep learning-based AI system.

An artificial intelligence technology is composed of machine learning (deep learning) and elements technologies using the machine learning.

Machine learning is an algorithm technology that classifies/learns the features of input data by itself, the element technology is a technology that reproduces the functions of the human brain such as recognition and determination, and is composed of technological fields such as linguistic understanding, visual understanding, inferring/estimating, knowledge expressing, and motion controlling.

Deep learning is defined as a series of machine learning algorithms that attempt to achieve high levels of abstractions (a task that summarizes core content or functions in large amounts of data or complex data) through a combination of several nonlinear transformation techniques. Deep learning can be viewed as a field of machine learning that teaches computers how people think in a large frame.

There is much research in progress on how to represent data in a form that the computer can understand (for example, pixel information is represented by a column vector in the case of an image) and how to apply it to learning (how to make better expression techniques, and how to create models to learn them). As a result of these efforts, various deep learning techniques have been developed. Deep learning techniques include Deep Neural Networks (DNN), Convolutional deep Neural Networks (CNN), Recurrent Neural Networks (RNN), and Deep Belief Networks (DBN).

Deep Neural Networks (DNN) is an artificial neural network (ANN) composed of a plurality of hidden layers between an input layer and an output layer.

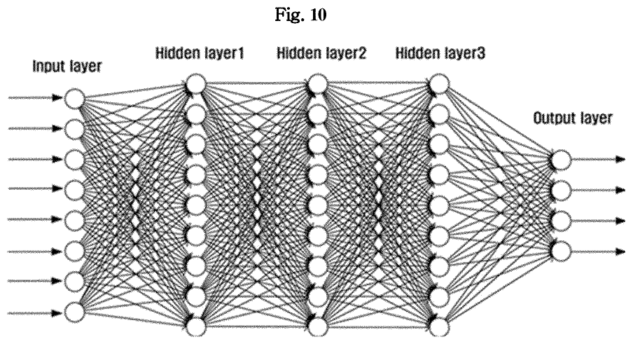

FIG. 10 is a diagram illustrating a structure of a deep neural network. In FIG. 10, each circle represents one perceptron. A perceptron consists of multiple input values, a processor, and a single output value. The processor multiplies the multiple input values by their respective weights. Then, all the input values multiplied by the weights are added. The processor then substitutes the summed value into the activation function to produce one output value. If a specific value is desired as the output value of the activation function, it is possible to modify the weight multiplied by each input value and recalculate the output value using the modified weights. In FIG. 10, each perceptron may use different activation functions. Also, each perceptron receives the outputs from the previous layer as input, and then uses the activation function to obtain the output. The resultant output is passed as the input for the next layer. Following the process described above, several output values can be finally obtained.

Returning to the description of deep running techniques, Convolutional deep Neural Networks (CNN) is a type of multilayer perceptrons designed to use minimal preprocess. The convolutional deep neural network consists of one or multiple convolutional layers and general artificial neural network layers stacked on top and also utilizes additional weights and integrated pooling layers. This structure allows the convolutional deep neural network to fully utilize the input data of two-dimensional structure. In addition, the convolutional deep neural network can be trained through standard back propagation. Convolutional deep neural networks are more easily trained than other feedforward artificial neural network techniques and have the advantage of using fewer parameters.

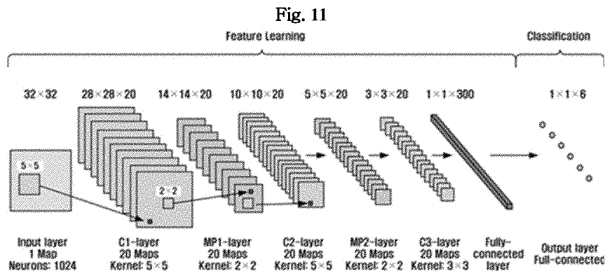

The convolutional deep neural network extracts features from the input image by alternately performing the convolution and sub-sampling on the input image. FIG. 11 is a diagram illustrating a structure of a convolutional deep neural network. According to FIG. 11, the convolutional deep network includes multiple convolution layers, multiple subsampling layers (Subsampling layer, Lacal pooling layer, Max-Pooling layer), and a fully connected layer. The convolution layer is a layer that performs a composite product on an input image. The subsampling layer is a layer for extracting a maximum value locally for an input image and mapping it to a two-dimensional image, enlarging a local region, and performing sub-sampling.

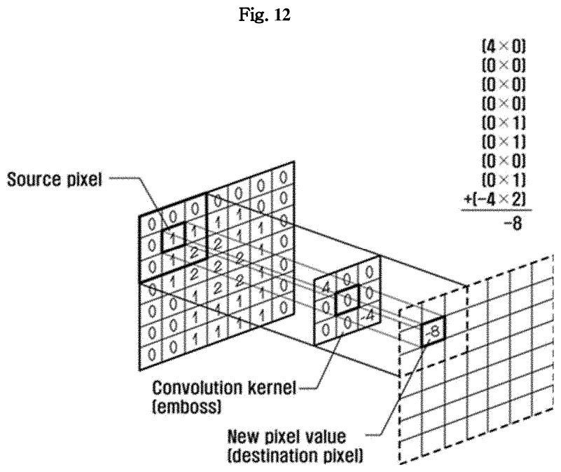

In the convolution layer, information such as the kernel size, the number of kernels to be used (i.e. the number of maps to be generated), and a weight table to be applied for convolution operation are required. For example, consider the case in which the size of the input image is 32×32, the size of the kernel is 5×5, and the number of kernels to be used is 20. In this case, applying a 5×5 kernel to a 32×32 input image makes it impossible to apply a kernel to two pixels at the top, bottom, left, and right of the input image. It is because as shown in FIG. 12, when a kernel is placed on the input image and convolution is performed, the resulting value, ‘-8’, is determined as the number of pixels corresponding to the center element of the pixels of the input image included in the kernel. Therefore, if a 5×5 kernel is applied to a 32×32 input image and convolution is performed, a 28×28 map is generated. Since it was previously assumed that the number of kernels to be used is 20 in total, a total of 20 28×28 maps are generated in the first convolution layer (see “C1-layer” in FIG. 11).

In the subsampling layer, information on the size of the kernel to be sub-sampled and information on whether to select the maximum value or the minimum value among the values in the kernel region are required. FIG. 120 is a diagram illustrating a sub-sampling process. In FIG. 120, it can be seen that the size of the kernel to be sub-sampled is set to 2×2, and the maximum value among the values included in the kernel area is set to be selected. By applying a 2×2 kernel to an 8×8 input image, a 4×4 output image can be obtained. That is, an output image whose size is reduced to ½ of the input image can be obtained.

Returning to the description of the deep learning techniques, the Recurrent Neural Network (RNN) refers to a neural network in which the connections between the units forming an artificial neural network constitute a directed cycle. Recurrent neural networks can utilize memory inside a neural network to process arbitrary inputs, unlike feedforward neural networks.

Deep Belief Networks (DBN) is a generative graphical model used in machine learning. In deep learning, it is a deep neural network composed of multiple layers of latent variables. There is a connection between layers, but there is no connection between units in the layer.

The deep belief networks can be used for pre-learning due to the nature of generation model, and it can learn the initial weight through pre-learning and then fine-tune the weights through back propagation or other discrimination algorithms. This characteristic is very useful when the training data is small, because the smaller the training data, the more the initial value of the weight affects the resulting model. The pre-learned weight initial value is closer to the optimum weight than the arbitrarily set initial weight value, which enables the performance and speed improvement of the fine-tuning step.

The description about artificial intelligence and learning method thereof is an example, and the artificial intelligence and the learning method thereof that are used in the following embodiments are not limited. For example, all kinds of artificial intelligence technologies and the learning methods thereof that those skilled in the art can apply to solve the subject matters may be used to achieve a virtual reality device, method, and system according to the disclosed embodiments.

A virtual reality device according to a disclosed embodiment may use the brain waves of a user in some or all embodiments. The brain waves are classified into a delta wave, a theta wave, an alpha wave, a beta wave, and gamma wave in broad meaning, depending on the magnitude of the frequency.

The virtual reality device includes at least one module for acquiring the brain waves of a user.

For example, the virtual reality device according to a disclosed embodiment may include at least one electroencephalogram (EEG) device for acquiring the brain waves of a user. The EEG device, which measures electrical activities by a cerebral activity of an examinee (user), can collect and measure brain waves that are generated by electrical signals by the cerebral activity of a user.

Further, the virtual reality device according to a disclosed embodiment may include at least one brain stimulation module that can provide a stimulus corresponding to brain waves to the user's brain.

For example, the virtual reality device according to a disclosed embodiment may include a Transcranial Magnetic Stimulation (TMS) device. TMS is non-invasive therapy for the nervous system and has the advantage that it is possible to cure nervous system diseases and stimulate the brain without medicinal treatment or invasive treatment. TMS can apply an electrical stimulus to an object (e.g., the user's brain) using a change of a magnetic field.

The virtual reality device according to a disclosed embodiment may further include at least one module or device that can take cerebral MRI videos to increase accuracy and precision of brain wave measurement and brain stimulation.

MIR equipment can acquire the information about the structure of a brain and the type of the network system of a brain, but the order is difficult to determine. However, it is possible to acquire the information about the order too using brain waves.

An MIR system is a device that acquires images of layers of an object by expressing the intensity of Magnetic Resonance (MR) signals to Radio Frequency (RF) signals, which are generated in a magnetic field with specific intensity, as brightness contrast. For example, when an RF signal, which resonates only specific atomic nuclei (e.g., hydrogen atomic nuclei), is instantaneously radiated to an object lying in a strong magnetic field and is then stopped, the specific atomic nuclei emit MR signals. An MIR system can acquire MR images by receiving the MR signals. The MR signal is an RF signal radiated from an object. The magnitude of an MR signal may depend on the concentration of specific atoms (e.g., hydrogen) in an object, a relaxation time T1, a relaxation time T2, bloodstream, etc.

An MRI system has features discriminated from those of other imaging devices. Unlike imaging devices that depend on the direction of detecting hardware to acquire images such as a CT device, an MRI system can acquire 2D images or 3D volume images direct to a specific point. Further, an MIR system, unlike CT, X-ray, PET, and SPECT, can acquire an image with high softtissue contrast without exposing an object and an examiner to radioactive rays, and can acquire a neurological image, an intravascular image, a musculoskeletal image, an oncologic image, etc., in which clear reproduction of abnormal tissues is important.

In detail, an MRI system according to an embodiment includes a gantry, a signal transceiver, a monitoring device, a system controller, and an operator.

The gantry prevents electromagnetic waves generated by a main magnet, a gradient coil, an RF coil, etc. from being radiated outside. A static magnetic field and a gradient magnetic field are generated in the bore of the gantry, and an RF signal is radiated to an object.

The main magnet, the gradient coil, and the RF coil may be arranged in a predetermined direction of the gantry. The predetermined direction may include a coaxial barrel direction. etc. An object may be positioned on a table that can be inserted in a barrel in the horizontal direction of the barrel.

The main magnet generates a static magnetic field for arranging the direction of magnetic dipole moment of atomic nuclei in an object in a predetermined direction. The stronger and the more uniform the magnetic field generated by the main magnet, the more precise and accurate the MR videos can be acquired from an object.

The gradient coil includes X-, Y-, and Z-coils that generate gradient magnetic fields in X, Y, and Z axes that are perpendicular to each other. The gradient coil can provide the location information of each part of an object by inducing different resonance frequencies for the parts of the object.

The RF coil can radiate an RF signal to a patient and can receive an MR signal discharged from the patient. In detail, the RF coil can transmit an RF signal having the same frequency as the frequency of precession to atomic nuclei in a patient making precession and then stop transmitting the RF signal, and can receive MR signals discharged from the atomic nuclei in the patient.

The configuration of the MRI system described above is provided as an example and the configuration of a system that is used to acquire magnetic resonance videos herein is not limited thereto.

According to a disclosed embodiment, the virtual reality device may include a helmet-type device that is worn on the head of a user to acquire at least one of the brain waves and MRI videos of the user.

For example, the virtual reality device may be configured in a goggle type combined with a helmet-type device, but is not limited thereto.

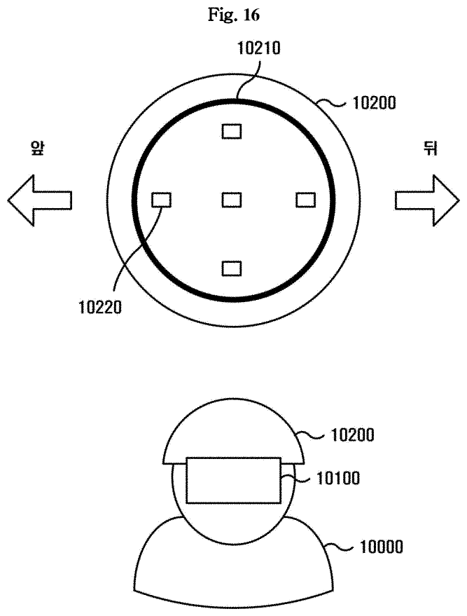

FIG. 16 is a view showing a virtual reality device and a helmet-type device combined with the virtual reality device.

Referring to FIG. 16, an example in which a user 10000 wears a virtual reality device 10100 and a helmet 10200 is shown.

The directions ‘front’ and ‘rear’ shown with respect to the helmet 10200 in FIG. 16 are provided for the convenience of description and any configuration is not limited thereto.

Referring to FIG. 16, the virtual reality device 10100 may be integrated with the helmet 10200 and they may be configured as independent devices and connected to each other.

Referring to FIG. 16, the helmet 10200 includes one or more brain wave modules 10220 for measuring brain waves of the user 10000. The brain wave modules 10220 include at least one electrode or brain wave sensor that is used to measure the brain waves of the user 10000. In an embodiment, the brain wave modules 10220 are disposed at several positions in the helmet 10200 and are used to measure the brain waves of the user 10000.

In an embodiment, the brain wave modules 10220 may further include at least one electrode or current or magnetic field generation module that can stimulate the brain of the user 10000.

In an embodiment, the helmet 10200 may include a small-sized MRI device 10210.

The MRI device 10210 includes a gantry, a signal transceiver, a monitoring device, a system controller, and an operator. The MRI device 10210 is formed by reducing these components in the size of the helmet.

The gantry included in the MRI device 10210 prevents electromagnetic waves generated by a main magnet, a gradient coil, an RF coil, etc. from being radiated outside. A static magnetic field and a gradient magnetic field are generated in the bore of the gantry, and an RF signal is radiated to an object. The main magnet, the gradient coil, and the RF coil may be arranged in a predetermined direction of the gantry. The predetermined direction may include a coaxial cylindrical direction. etc.

A table that can be inserted into a barrel along the horizontal axis of the barrel is included in common MRI systems, and an object is supposed to be placed on the table. However, according to the embodiment shown in FIG. 16, the MIR device 10210 is provided at the helmet, and the helmet is supposed to be put on the head of the user 10000 and is used to acquire MRI videos of the head of the user 10000.

Hereafter, embodiments that can be performed by the virtual reality device according to the disclosed embodiment and the brain wave measurement and brain stimulation device described above are described in detail.

In an embodiment, a virtual reality device can control all kinds of devices, which can directly or indirectly communicate with the virtual reality device such as a vehicle, a home appliance, and a computer, using the brain waves of a user.

In this specification, the operations that are performed by a virtual reality device may be stored in the virtual reality device or may be performed on the basis of artificial intelligence that can be accessed through the virtual reality device.

In this specification, user input that is given to a virtual reality device is understood as a concept including user input that is acquired using the brain waves of a user.

Hereafter, the term “virtual reality device” is understood as a concept including a device for measuring brain waves and stimulating a brain (e.g., a helmet-type device).

In an embodiment, a virtual reality device can take pictures using brain waves. For example, the virtual reality device acquires information about the direction and point in time at which a user wants to take pictures, using the brain waves, and take pictures. Further, the virtual reality device can automatically take pictures in more accurate direction and at more accurate point in time using at least one of information about the focus of a user, the positions and movement of pupils, movement of the muscles around the eyes, and the direction that a user looks at, and stagnation time, in addition to brain waves.

In an embodiment, the virtual reality device can make an image of a specific point in time in the brain of a user using brain waves. For example, the virtual reality device can make past memories or necessary memories of a user come back using the brain waves of the user. The virtual reality device searches a database corresponding to information acquired from the brain waves of a user and acquires images and videos having similar patterns or images and videos stored in the past, using artificial intelligence. Further, the virtual reality device can acquire or estimate images corresponding to acquired brain patterns of a user, using information about matching and similarity of normal brain wave patterns of the user and videos and brain patterns stored in a database. In this case, it is possible to complete scenes one by one by recognizing a pattern that means concordance and a pattern that means discordance and it is also possible to implement similar images, when creating past scenes.

Further, when a specific image or specific information is given to a user and is information that the user knows or is an image that the user has seen, a pattern of a brain wave that is generated by recalling existing memories. The virtual reality device according to the disclosed embodiment acquires the patterns of such brain waves, thereby being able to provide a specific image or information to the user and being able to acquire information about whether the image or information is information (or image) that the user has known. For example, this may be used for lie detection. For example, it is possible to detect a lie of a user by showing a picture of a victim to a criminal or providing images or information about a crime scene and then determining whether a brain wave pattern corresponding to the memory of the user is activated.

Further, the virtual reality device according to the disclosed embodiment can keep brain patterns respectively corresponding to an image that a user looks at, a thought of a user, an action of a user, and a state of a user. Using a database acquired in this way, the virtual reality device can read out a thought of a user or can estimate an action of a user only by measuring the brain waves of the user. In this case, it is possible to remove patterns that interfere with a purpose by extracting and analyzing a similarity pattern of the past and the current, which can be used as a data for comparing and analyzing general pattern information of human.

In this case, when constructing a database, the virtual reality device can classify subdivided measurement information for each category of actual experiences or actions of a user and can remove noise by filtering out information, which is acquired by interfering with the purpose, such as a reaction to a sudden undesired horn sound.

In an embodiment, the brain waves of human may slightly different every day and may be changed by the physical condition. The virtual reality device according to the disclosed embodiment can acquire accurate brain wave information by correcting a predetermined error range in consideration of these differences. For example, even if a brain wave slightly different from the brain wave corresponding to a specific memory is acquired, a brain wave within a predetermined range can be handled as the same brain wave in consideration of a state change of the user.

Strictly speaking, in a microscopic world, yesterday's human is human different from today's human and is an object. Accordingly, the radiation pattern of brain waves may be considered as slight changing every day. When there is an action, there is an inherent pattern of a brain wave. When the inherent pattern is matched over a predetermined level in terms of continuity, it is admitted as the same person. A virtual reality device keeps the patter of a brain wave and automatically corrects the pattern system of a changed brain wave to fit to the original system, every time it is used, thereby being able to automatically correct the order system of brain waves.

The virtual reality device according to the disclosed embodiment and an accompanying brain wave measurement device may be used even to measure the brain waves of animals.

The virtual reality device can interpret and provide the states of animals, such as hunger, anger, loneliness, delight, boredom, good feeling toward the opposite sex, agreement, refusal, unpleasantness, dirtiness, cleanness, sleepiness, rest, desire for exercising, curiosity, indifference, and desire for consensus, into the human language by capturing brain wave signals from the animals and comparing and analyzing the brain wave signals with the behaviors of the animals. Further, in order to acquire a database for this purpose, it is possible to construct different databases for the species of animals by performing tests according to various settings and the species or it is possible to construct a database that enables interpretation of the states or languages of animals by setting specific standards and measuring brain waves regardless of the species. Facial expression and action pattern analysis may be included in this process.

In the following embodiment, the virtual reality device can construct a database by storing a history based on various actions of a user and a brain wave corresponding to each history. The virtual reality device can acquire various items of information from the brain waves of the user using the constructed database.

In an embodiment, the virtual reality device can construct a database by matching things that a user has wanted (e.g., a search log, a call log, a purchase history, etc.) with brain waves on the basis of existing records of the user. The virtual reality device can acquire information about wants of a user on the basis of the brain wave pattern of the user and the brain wave pattern stored in a database, using the database. Further, the virtual reality device can determine an image corresponding to the brain wave pattern of a user and can acquire information about a birthday present, a destination, or the like that the user wants, on the basis of the determined image, etc. Further, the virtual reality device can acquire the information described above by collecting a positive pattern that is received when a user sees a certain item.

Similarly, the virtual reality device can bring a solution to a wish of a user and can find out a worry of a user and can help solve the worry by comparing the ordinary inherent patterns of worries of the user with the current brain wave pattern of the user. Further, it is possible to prevent a user from making an error by comparing the current brain wave pattern with the brain wave patterns of specific actions such as suicide, a crime, etc. of the user.

The virtual reality device may be used as a game prevention technology by analyzing the brain waves of a user and analyzing good feeling, annoyance, abuses, stress, the degree of fatigue, a game time, game desire, the degree of addiction, etc. of the user when the user is playing a game. For example, the virtual reality device can finish or stop a game or can adjust and distribute a game time.

In an embodiment, the virtual reality device can analyze the brain waves while a user is asleep. The virtual reality device can statistically analyze the information about a sleep time such as the degree of a deep sleep, the degree of fatigue, lack of sleep, and a dreaming time on the basis of the brain waves of a user while the user is asleep. The virtual reality device can acquire the information about the time when a user gets a sleep and wakes up on the basis of the analysis result and can analyze and provide the biorhythm and the quality of the sleep for the sleep time.

The virtual reality device can determine whether there is a problem with healthy of each part of the user's body and may be configured to be able to naturally acquire brain waves while a user is asleep using at least one brain wave sensor in bedclothes such as a bed, a pillow, and a mattress.

The virtual reality device can analyze the sleep habit, the quality of sleep, the degree of the resultant fatigue, etc., of a user and can provide necessary advice to the user. In this case, it is possible to provide brain waves or sound waves that helps sleep independently or in cooperation with various devices such as a sleep eye bandage, earphones, a pillow, and a bed. Further, it is possible to provide a brain wave that helps sleep or a brain wave that awakes the user from sleep at desired time.

The virtual reality device can color a virtual space or an image file using the brain waves of a user. For example, the virtual reality device can paint a position that a user wants with a color that the user wants, or can change the color on the basis of the brain waves of the user. In this case, all the following biological recognition methods can be combined.

Further, the virtual reality device can change the hair colors of surrounding people on the basis of the brain waves of a user in a virtual space. Similarly, the virtual reality device can implement imagination of a user on the basis of the brain waves of the user in a virtual space.

The virtual reality device may operate together with a massage device such as a massage chair. The virtual reality device can control a massage device in various ways such as partial selective massaging, repetitive messaging, time setting, strength adjusting, hot/cold compressing, tightening adjusting, vibrating, shaking, and radiating and adjusting high-frequency far infrared rays, by analyzing the brain waves of a user.

The virtual reality device can control an internal environment on the basis of the brain waves of a user in cooperation with an internal IoT environment. For example, when a user feels cold, it is possible to turn off an air conditioner and change a wind direction and a temperature for each level, and it is also possible to remove humidity, remove smell, and generate perfume through the air conditioner. Further, when a user feels hot, the virtual reality device can turn of a boiler. Further, when a user makes a signal that he/she wants to turn on or off an air conditioner or a boiler while looking at the air conditioner or the boiler, the virtual reality device can operate with a recognition device of the boiler or the air conditioner and can also control the air conditioner or the boiler by sensing brain waves. In this case, the biological information of the user such as sweat can be used and other external devices may be used. Sensing and operation can be performed even though the user is asleep.

Further, the virtual reality device can automatically control the interior temperature on the basis of the number of people, the value of a brain wave measured when a user feels cold, time, the season, the weather, etc., in cooperation with cooling/heating devices such as an air conditioner or a boiler.

The virtual reality device can achieve these functions even by controlling or using a hot blast heater, a heater, or the like.

The virtual reality device can read out thoughts of a user or another person. Accordingly, when a user does not want to show his/her thought to another person or wants to lie, the virtual reality device can transmit a false thought different from the actual thought of the user or a brain wave corresponding to the false thought to the another person.

In addition to the virtual reality device, various types of chips in a brain or a wearable accessory that is worn on a portion spaced part from a brain may be used to connect brain waves. The wearable device may include at least one sensor device or computing device and may include, for example, a hair band, an earring, a watch, a necklace, bracelet, and other personal ornaments, but is not limited thereto.

The virtual reality device can determine the user's thought (or real intention) on the basis of the voiceprint or brain waves of a user. Further, the virtual reality device can perform authentication based on the voiceprint or brain waves of a user. Accordingly, the virtual reality device can perform remittance on the basis of the brain waves of a user.

For example, the virtual reality device can recognize a user's intention of remit money to a specific person (e.g., the information about the person, the remittance money, account information, bank information, password pattern input intention, and confirmation), using brain waves together with the a look in the user's eyes, an action of the user, biological information, and other actions, can perform authentication using the brain waves, and can remit the money to the person when authentication is succeeded.

Similarly, the virtual reality device can purchase articles and pay money using the brain waves of a user. The virtual reality device can select and purchase a desired article and pay money using the brain waves of a user in a virtual space. In reality, it is possible to pay through a POS system after determining and authenticating an object on the basis of the brain waves and actions of a user.

In a disclosed embodiment, the virtual reality device can manage a virtual money wallet. For example, the virtual reality device can manage, keep, and move a virtual reality wallet disposed in a server or a client and can operate after performing recognition and authentication based on general biological information of a user (e.g., an action, the iris, the lines on the palm, a vein pattern, a fingerprint, a voice print, the location of the user, recognition of a pattern that can be continuously connected with a movement direction of the user, combination of time for each transportation, analysis of a resultant value, biological information including the shape of a face, and a brain wave).

Human changes in physical condition due to growing or aging as time passes, and the physical condition is changed also by the everyday health state. Accordingly, even if it is the same person, yesterday's person and today's person may change, and today's person and tomorrow's person may change.

Accordingly, the brain wave pattern of a user may also change continuously or depending on situations. A brain wave may be a signal transmission between neurons in the brain and a predetermined algorithm or a following effect accompanying the signal transmission, or may be an electrical signal that is generated when an action is performed. Accordingly, even if the same person performs the same action, the pattern of the brain wave may slightly change every time.

In the disclosed embodiment, it is assumed that the brain wave pattern of a user may always slightly change. Accordingly, brain wave patterns stored in a database are compared when the brain waves of a user are analyzed, but, in this case, a completely same brain wave pattern is not found out and the brain wave patterns are compared in consideration of a slight error.

The virtual reality device can sense the pulse and bread of a user too. The virtual reality device determines feelings of a user and opposite feelings corresponding to the feelings using at least one of the brain wave, the pulse, and the breathing of the user.

Further, the virtual reality device can determine the feelings of a user on the basis of the voice print and fine movement of muscles of a user.

In detail, the virtual reality device can generally measure a facial expression, movement of muscles, a gesture, the pulse at muscles around the eyelids and eyes, the body temperature, the sound of breathing, the voiceprint, a biological phenomenon of the voice, and the brain waves of a user, and can analyze and express the mood of the user in a virtual reality or the reality.

Further, the virtual reality device can analyze the brain waves of a user, can transmit the feeling of the user to another person in percent, and can read out the feeling of the another person. Accordingly, the virtual reality device can determine the degree of interest in a user of another person, and can know in advance whether they have a good feeling toward each other.

Further, the virtual reality device can acquire information about the property of a user such as whether the user is smart or not, whether the user is diligent or not, on the basis of the brain waves of the user.

In the disclosed embodiment, the virtual reality device may include a brain wave amplifier for amplifying the brain waves of a user. The kind of the brain wave amplifier is not limited and the virtual reality device may include at least one brain wave sensor module inside the skull or close to the brain to more accurately measure brain waves.

In the disclosed embodiment, the virtual reality device can manipulate various external device or vehicles using the brain waves of a user. The virtual reality device can manipulate various external devices or vehicles in a virtual space or a real space.

People may have different brain wave patterns. However, when data are accumulated, it is possible to perform learning through deep learning and derive similarity of patterns according to cases. For example, even if they are different people, brain waves with a similar pattern may be at least partially generated when they look at the same image, and the virtual reality device can derive such a feature through learning and can recognize the brain waves at a certain level even without a personalized database.

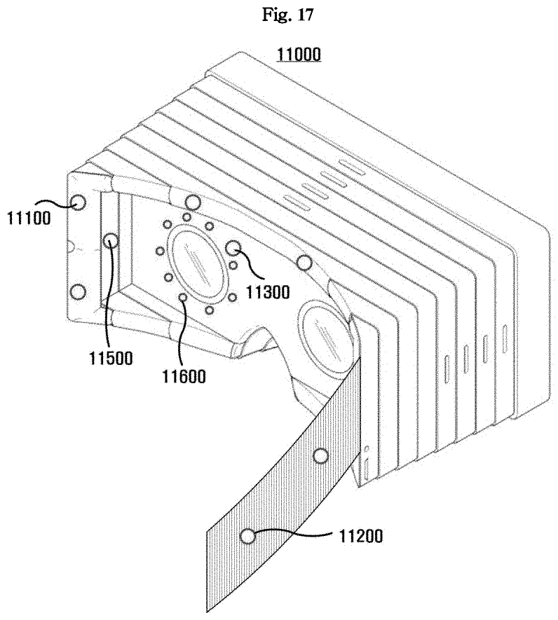

FIG. 17 is a view showing a virtual reality device including a brain wave module according to an embodiment.

Referring to FIG. 17, a virtual reality device 11000 includes one or more brain wave module 11100 including an ocular plate and disposed along a contact portion that comes in contact with the face of a user. The brain wave module includes at least one electrode or brain wave sensor for sensing the brain waves of a user. The installation position of the brain wave module 11100 is not limited.

In an embodiment, the brain wave module 11100 may further include a brain wave amplifier that can amplify the brain waves of a user and a noise removal module for removing noise in brain waves. The brain wave module 11100 can remove noise even from amplified brain waves.

In an embodiment, brain wave modules 11200 may be disposed on the band of the virtual reality device 11000. The brain wave module 11200 is disposed on the band of the virtual reality device 11000 to come in contact with or come close to the face or the head of a user and can be used to sense and amplify brain waves from the brain of a user and to remove noise.

In an embodiment, the virtual reality device 11000 has a grip at an end of a plate, so a user can slide and open the outer wall of the virtual reality device 11000 using the grip.

In an embodiment, at least one vent 11300 may be formed at the ocular plate of the virtual reality device 11000. The vent 11300 is used to recognize movement, etc. of the eyes of a user or the muscles around the eyes using a camera or at least one sensor.

When a user wearing the virtual reality device sets the direction of a virtual target, the virtual reality device can recognize movement of the pupils. Further, the virtual reality device can recognize movement of the whites around the eyeballs and the eye muscles, in detail, the muscles of the upper and lower eyelids.

One or more sensor for recognizing movement of the eye muscles of a user may be disposed inside vents or at vents 11300 or a side 11500 and vents 11600 through which the sensors are exposed may be formed around a lens.

Further, the virtual reality device can recognize blink of user's eyes, movement of the whites, the eyelids, and the muscles around the eyes due to movement of the eyeballs. The virtual reality device can analyze the direction that a user looks at or the movement direction of the gaze, using the movement described above, and can reflect the direction to a virtual reality video.

Further, the virtual reality device can estimate the direction in which a user will move on the basis of movement or directions of the head, the shoulder line, the waist, the body, the ankles, the knees, the feet, etc. of the user, and can make a virtual avatar or the user move in the direction. For example, when a user starts movement to move in a specific direction while moving in a virtual space, the virtual reality device can recognize the movement and can control the user or an avatar in the virtual space to perform an action corresponding to the movement in advance before the user stops the movement. Accordingly, even though the user finishes the action in person, he/she can control the avatar in accordance with his/her intention or control the avatar to move faster than the speed at which the user can actually move.

Further, the virtual reality device can specify the object user looks at by using the method described above and recognizing the eyes' angle and distance and the brain waves of the user. Accordingly, it is possible to move virtual articles and perform an act corresponding to a click, ascertaining, checking, etc.

Further, the virtual reality device can determine whether the user's eyesight fails (e.g., whether the gap between the upper and lower eyelids narrows, whether the sizes of the pupils change, whether a user frequently frowns due to weak eyesight, or the like) by analyzing the movement and states of the user's eyes and the parts around the eyes, and can determine the state of the user's eyeballs on the basis of a change of the pupils or the irises due to light.

In the disclosed embodiment, the virtual reality device can perform one or more cancelable step to prevent malfunction due to wrong brain wave determination such as when there is an error in brain wave determination or a user zones out for a while. For example, when there is a possibility of wrong control due to wrong imagination, distracting thoughts, or an unexpected surrounding situation during driving, the virtual reality device can determine the possibility and can provide options for whether to actually perform the corresponding order, whether to cancel the order, or whether to stop performing the order through button or voice input, various facial patterns and gestures, a nod, a blink, and other bodily actions.

Similarly, the virtual reality device can correct a wrong order using brain waves. The virtual reality device can determine an order from a user, a surrounding situation, a current status, etc., and can determine whether an order according to a brain wave of the user is a wrong order.

In the disclosed embodiment, the virtual reality device can analyze the brain waves of a user, can move to a virtual space, which a user wants, even though the user does not give a specific order, or can determine and perform in advance an order that a user wants.

In an embodiment, the virtual reality device can determine the intention of a user on the basis of a brain wave, a gaze, a gesture, and other input of a user, and can provide information about a corresponding location or place. Further, the virtual reality device can instantaneously move the user to a virtual location corresponding to the user's intention.

In the disclosed embodiment, the virtual reality device can perform a function of removing noise when analyzing brain waves. For example, the brain waves of a user may include noise due to reaction to noise such as a surrounding car sound when data are accumulated. Accordingly, it is possible to remove a brain wave corresponding to reaction due to surrounding stimuli from all brain waves, extract only a brain wave corresponding to the normal brain wave pattern of a user, that is, determined as the brain wave pattern of a user, and perform analysis on the basis of the extracted brain wave pattern.

Since the brain wave patterns of people are all finely different, the virtual reality device can learn, map, subdivide, and code the differences and can learn and provide an optimal code pattern for each user.

The code patterns optimized for each user may be stored not only in the virtual reality device, but also in an external server or a cloud server. The code patterns can be downloaded and provided when a user uses another virtual reality device or an electronic device, whereby brain wave analysis personalized to fit to users can be provided anywhere.

Similarly, an USB type storage device that can store and analyze brain wave data of a user and can convert and transmit the brain wave data into a standard order system may be used. When the USB device is inserted in an external device, the external device can provide brain wave analysis personalized for a user and other personalized services, and the virtual reality device may also have a system in which an USB can be inserted and that is installed therein.

The virtual reality device can analyze a brain wave, which is involved with a space, a target, etc., from a user, and can use the analysis to purchase a product and check the location of a target in a virtual reality space.

Brain waves may be differently discriminated in accordance with the regions that they respectively have charge of. For example, there may be a brain wave that is involved with and reacts to only colors and there may be a brain wave that is involved with only images. Accordingly, the virtual reality device can discriminate and use the brain waves in various fields. For example, the virtual reality device can analyze specific images such as a mountain, water, sea, and a ship, and specifically, can specify a sound, a character, the sense of touch, the sense of taste, light, darkness, the sense of smell, a size, an area, a distance, a vertical/horizontal angle, a space, weight, a speed, a time concept such as the past, the future, an hour, a minute, a second, a year, and a month, and each part such as virtual and real space concepts, and a memory. For example, it is possible to use tests or analysis result data.

That is, the virtual reality device does not acquire all from one brain wave, but analyzes subdivided brain waves for subdivided contents and applies and learns the brain waves respectively different data, thereby being able to subdivide and analyze brain waves in various types, for example, by using a brain wave to be applied first in each field and a corresponding model or by giving a higher weight (percent) for each brain wave information. Biological information of a user may be combined therein.

Further, the virtual reality device can analyze and digitize brain wave pattern data of a user in a virtual or real image and can use the result to acquire an order later. For example, it is possible to make a database by digitizing data such as the color, area, and movement of an image, and it is possible to take the data as the base that makes it possible to analyze each content by comparing the data with the brain waves of a user.

For example, it is assumed that there is Cola. In this case, it is possible to determine whether the object is a can or a bottle by extracting first a brain wave for measuring a space. Further, it is possible to determine that it is Cola using a color, and it is possible to analyze the brand and separately determine each element such as an area or a size.

Further, it is possible to recognize an object through less determination processes by determining details later and determining important features first.

As a detailed example, in addition to apply all the examples described above, for example, the virtual reality device can show mount to a user and then measure brain waves and can show sea and then measure brain waves. Further, a mountain and sea may be combined in measurement. Further, it is possible to construct a database of brain waves by measuring a brain wave pattern according to various changes such as movement of a tree in a scene or moved in the north, east, west, and south. It is possible to store, analyze, combine, and apply brain wave analysis according to activities of a user in this case. Thereafter, when applying new information later, it is possible to further reduce errors and accurately recognize and perform an order according to a brain wave on the basis of the brain wave analysis.

In an embodiment, the virtual reality device can measure brain waves of anxiety, worry, anger, gloom, stress, surprise, instability, tension, etc. of a user and can cure them using music, a video, conversation, sound waves, and brain waves. Further, various external devices may be operated together in this case.

In an embodiment, when a brain wave that interferes with learning is measured when the virtual reality device measures brain waves involved with a learning ability such as languor, sleepiness, tension, and failing of memory, the virtual reality device can finely adjust brain waves using music, an image, conversation, sound waves, brain waves, etc. optimized for concentration and awaking. Further, various external devices may be operated together in this case.

Further, the virtual reality device may provide a help for improving the state of a user such as exercise, reading, and other advices.

When a user feels fain, the virtual reality device can stimulate various senses, such as happiness, stability, peace, comfort, ecstasy, and orgasm, with a brain wave or can provide a voice, a video, a sound wave, etc. that can stimulate a brain wave.

Similarly, when stress is sensed from a user, it is possible to provide the stimuli describe above, in which the sense can be sensed on the basis of a change in physical state of the user such as skin temperature, skin resistance, a brain wave pattern, etc. of the user.

The virtual reality device measures a location or a brain wave with a pattern that corresponds to a specific disease and can determine and provide the possibility of a corresponding disease using a wearable accessory type brain wave analyzer that can be worn on many parts of a body. In an emergency, the virtual reality device can let a general practitioner, 119, or other acquaintances know the state of a user.

The virtual reality device stores different brain wave patterns of people to correspond to images of specific stimuli and corresponding reactions. Thereafter, when a user shows a specific brain wave pattern for the same video, for example, when a user turns on a game and logs in or performs a specific order, it is possible to reduce the procedure time and prevent the user from repeating complicated actions by automatically performing the same operation on the basis of the brain wave pattern even without repetitive operation. In this case, the virtual reality device can copy an action pattern and a biological image of the user as data and apply the data to achieve the technology.

The virtual reality device can use the database described above for a similar image that it newly counters. In this case, it is possible to acquire a new brain wave pattern, separate an action part and a pattern part from the brain wave pattern, and use them to perform orders respectively corresponding to the patterns. Further, the virtual reality device can handle by itself an action that the user wants also in a new image. For example, even it is a new game, it is possible to subscribe and log in, and it is possible to immediately start the game by matching the user.

In the disclosed embodiment, the virtual reality device may be equipped with a brain activation sensor or a brain wave generation sensor or may further include a band that can activate at least a portion of a brain, and the sensors that can activate a brain can stimulate several parts of the user's brain separately or on a headband.

As the brain is activated, the user more strongly show various items of information such as a lie, an interest, indifference, concentration, tiredness, happiness, anger, and excitement, and the virtual reality device can more accurately determined the state of the user by measuring them. It is also possible to diagnose a disease of the user, using corresponding periodic brain activation and observation. For example, when a specific part of the user's body is not good, stress expression for resisting the poor part may be generated through the brain, and the virtual reality device can analyze and measure the expression.

The virtual reality device can match only a brain wave pattern corresponding to the voice of a user in a database except for a surrounding environment such as a sound, light, the sense of hearing, the sense of touch, the sense of sight, the sense of smell, and the sense of taste, or an emotional environment such as anger, excitement, uneasiness, gloom, and stress. The virtual reality device can acquire a voice corresponding to the brain wave pattern of the user using the database, and can convert a brain wave of the user into a voice and transmit the voice to the outside or another person.

That is, the virtual reality device excludes brain waves other than a brain wave related to a voice and can perform learning so that users can communicate with each other through telepathy using it. That is, with brain wave patterns that are reflected by an external environment removed, and if necessary, the brain wave about a feeling also removed, the virtual reality device can transmit parts, characters, and speech (voices) imagined by a user or can receive them through images, characters, and voices, etc. Alternatively, the virtual reality device can communicate with a person or an animal through telepathy using an external device, and can operate with connected peripherals. The connected peripherals may include various sensors such as a hat, a headphone, an earring, an earring-shaped assembly, glasses, a hearing aid, an hairpin, artificial hair, other head accessories, and an earphone that are equipped with a brain wave sensor, a brain wave measurement sensor, a speaker, a camera, a distance measurement sensor, a contact sensor, an infrared sensor, a body temperature sensor, a temperature adjustment module, a fan module, a remote controller module, an electric shock module; environment controllers, IoT equipment, and a communicator for controlling them, but are not limited thereto.

Further, the virtual reality device can determine whether another person is lying, using the facial expression and voice print of the person, and a brain wave, depending on embodiments.

The virtual reality device can measure and make brain waves of a user that react images such as a specific figure or line into a database in a real or virtual space, and can perform a specific order or draw a picture using brain waves of the user on the basis of the database. For example, when a user imagine pressing a specific button while looking at the button in a virtual space, the virtual reality device can determine that the user presses the button in response to a corresponding brain wave. Further, when a user imagines drawing a picture on a virtual palette or in a virtual space, an image corresponding to the brain wave can be drawn.

In an embodiment, the virtual reality device can estimate the intelligence of a user on the basis of the brain waves of the user. Further, this may be used to determine the aptitude or the makings of the user.

For example, the virtual reality device can analyze the time that a user takes to do a specific kind of cerebral activity such as memorizing a specific word, remembering a specific content, spatial orientation, and numerical analysis, and can analyze the degree of satisfaction that is obtained in the process of dosing the cerebral activity on the basis of brain waves. Further, it is possible to analyze art and athletic senses such as music, art, and an athletic sense, and can analyze the degree of accomplishment and the corresponding degree of satisfaction on the basis of brain waves.

On the basis of the analysis, the virtual reality device can guide a course (aptitude) of the user or can coach the user by finding out shortcomings of the user.

The virtual reality device can copy the brain of a user by analyzing and copying an inherent brain wave pattern that reacts to a specific stimulus. Accordingly, it is also possible to estimate and infer an action pattern. Since examples of all reactions to stimuli are stored in the copied brain, the copied brain can operate like the user's brain. Accordingly, the virtual reality device can achieve an artificial intelligence copy brain. Using the artificial intelligence copy brain, it is possible to make artificial intelligence close to a natural person. Further, using the frame of a robot or human, it is possible to make an artificial intelligence robot or an android.

When the virtual reality device senses a brain wave that is determined as noise due to a temporal itch of the user's body or an external stimulus (noise etc.) while performing an order according to a brain wave, the virtual reality device determines that the brain wave goes against an intention of the user unless a specific danger is sensed, and can perform the work according to the existing intention of the user without immediately reflecting and following the brain wave.

The virtual reality device measures brain waves of a user in a real space, and can control movement of the user in a virtual space on the basis of the brain waves of the user such as making movement of the user fast or slow and making the user walk, run, and fly in the virtual space on the basis of information included in the brain waves. Accordingly, the user can move up to his/her resolution in the virtual space.

In an embodiment, the virtual reality device is worn on a head through a band. As shown in FIG. 17, the band may include at least one module that can scan brain waves.

The virtual reality device can set a virtual depository in a virtual space and can store any kind of virtual objects that a user wants. For example, a lock having a virtual money wallet, a cart, an article in a virtual space, image data, etc. can be stored. A user can store objects in the depository using a brain wave by imagining and trying to store them in the depository.

The virtual reality device can move a user to a specific virtual space using a brain wave. For example, when a user imagines sports such as baseball, soccer, billiards, bowling, and badminton, the user can enter a corresponding stadium in a virtual space.

The virtual reality device can measure an inherent brain wave of a user according to each event. The virtual reality device moves a user to a virtual place corresponding to a brain wave of the user.

When a user plays games, the virtual reality device can measure corresponding brain wave data and construct a database in the way described for accompanying acts.

The virtual reality device can make an order system using brain waves on the basis of the constructed database.

For example, the virtual reality device can make a user enter virtual places for a game, baseball, ski, martial arts, military arts, skate, golf, billiards, bowling, badminton, squash, ping-pong, tennis, shooting, riding, track and field, gymnastics, fishing, climbing, rafting, bungee jumping, motor cycling, hunting, a game, scuba diving, sports car driving, wind surfing, snorkeling, paragliding, hang gliding, swimming, diving, yachting, boating, horse racing, canoe, in accordance with brain waves of the user. Further, when a user only imagines virtual spaces or services that he/she wants, for example, for exercising, learning, music, SNS, shopping, weather, new, finance, video, travel, art, medicine, and childcare, the virtual reality device can provide corresponding services to the user.

The virtual reality device can sense vibration by input through a power button, etc. in a real space, and can turn on a corresponding device in a virtual space.

Further, when a brain wave state of a user is always sensed and the user recalls a specific image, the virtual reality device can be immediately turned on and can make the user enter a specific virtual space.

For example, when the virtual reality device acquires a memory at a specific past point in time from a user, the virtual reality device can make the user enter a past virtual space corresponding to the memory.

The virtual reality device has an IoT function that can control various devices, which can be connected, by measuring brain waves. The virtual reality device or the IoT device can deny performance or transmission of an order for a brain wave signal corresponding to noise of a user, which is applied even when a danger factor or a malfunction factor is sensed.

Further, IoT devices or the virtual reality device at a specific location (e.g., home) may be set to be able to be controlled on the basis of only the inherent brain waves of a specific user.

The virtual reality device always monitors brain waves of a user, and may consider and diagnose whether a user has dementia when an abnormal brain wave is sensed such as when the user newly has a learning ability disorder, lose his/her memory, has an orientation sense different from the past, does abnormal behaviors, or cannot recall for a long time things that he/she could usually immediately recall, or an action is delayed in the brain.

When the user's eyes get tired, the eyeballs get dry, or an object that a user looks at is doubly shown, the virtual reality device can sense these changes using brain waves. In detail, the virtual reality device can control a sensor mainly for the pattern of a brain wave corresponding to the visual field such as the eyesight of a user. The virtual reality device can give priority to a brain wave sensor for the part from which a brain wave corresponding to eyes is generated.

In an embodiment, the virtual reality device can lock or unlock electronic devices using the brain wave pattern of a user. For example, it is possible to perform biological authentication using the inherent brain wave pattern of each user or to acquire at least one password by analyzing a brain wave.

The virtual reality device uses one or more brain wave sensors, and in this case, the virtual reality device can apply different standards for measurement values of parts of a user. The brain wave sensor may be used to analyze an order from a user by analyzing a deep brain wave value that is measured for each part of the user.

An electronic device equipped with the brain wave sensor may be provided as a hat, a headphone, an earring, an earring-shaped assembly, glasses, an earphone, a hearing aid, a hairpin, and artificial hair, can operate a cell phone and a case by operating with the cell phone and the case using a brain wave, and can transmit/receive an information signal to/from an external device. Further, the virtual reality device can be combined with clothes.

When the virtual reality device senses a danger such as an accident, burying, a fire through a brain wave of a user, the virtual reality device can transmit a rescue signal to a close acquaintance or a government office. When the terminal of an acquaintance is turned off, it is possible to give notification so that the information is shown first when the terminal is turned on.

The virtual reality device may include a device that can acquire a magnetic resonance pattern, and can perform an order on the basis of the acquired magnetic resonance pattern.

A user can see a specific video from the virtual reality device and can enlarge the specific video or a menu using a brain wave, and the virtual reality device can easily receive and perform an order on the basis of the action. In this case, the order can be performed also by biological recognition related to the eyes.

The virtual reality device can enlarge a switch or a button shown in a virtual space so that it can be easily controlled.

The virtual reality device can perform unlocking using a brain wave of a user and can input a specific pattern through a pattern, a character plate, or a number plate in a video. The virtual reality device can acquire a brain wave having a pattern of imagining a user-only image (e.g., a pyramid, an apple, a car, and a lover) from a user and can perform authentication. Further, it is also possible to simultaneously physically press a button and perform authentication using a brain wave by being combined with common physical password buttons.

When a brain wave is sensed from a pillow or an attached sensor during sleeping and when an unstable brain wave pattern showing that a user has a bad dream or is unstable is sensed, the virtual reality device can awake the user by turning on the light or generating a sound or vibration, and can input all elements that can change the dream such as beautiful music, quiet music, humor, voices of family or a lover, etc. to induce the user has a good dream.

For example, it is possible to make a user have a happy dream by letting a user hear music that the user prefers or can help activate the brain by letting the user hear voice related to a foreign language or other subjects. Further, it is possible to obtain a predetermined training effect and enable in-sleep treatment, learning, etc. by inducing a user to have a dream about sports.

The virtual reality device can acquire and use a brain map for each part of a user. The virtual reality device can achieve a brain map of a user by giving aptitude tests and problems of various fields to the user and accumulating data in the process of solving them. The virtual reality device can determine the talent or aptitude of the user on the basis of the result, and in this process, a brain wave analysis module, MRI, a brain image, etc. can be used.

Further, it is possible to acquire various items of information such as a reaction speed, an athletic reaction speed, a reaction speed of each part of the body, and a problem solution speed to a video, a sound, and the sense of touch of a user, using the virtual reality device. The virtual reality device draws a brain map by collecting the acquired information and compares the brain map with that of an average person, and when a specific field is insufficient, the virtual reality device can induce the user to further make an effort for the corresponding field and to give up relevant jobs. Alternately, opposite guidance may be possible.

The virtual reality device can make a user be smart in a specific field using a brain wave.

For example, the virtual reality device can classify and provide all kinds of information by strengthening the design when a user uses a device. For example, the virtual reality device enlarges the design field when providing a video, broadcasting, a magazine, an exhibition, art, and news articles to a user, and increases the ratio of the design when providing a video, news, a magazine. etc.

Similarly, when providing shopping, a restaurant, a destination, a service, etc. to a user, it is possible to emphasize the design. Further, when a new design is released in the field that a user prefers, it is possible to provide the image and increase the ratio by specifying and subdividing the design. Further, it is also possible to give various design tasks to a user. Similarly, it is possible to provide an educational or learning service, and it is possible to activate and enlarge the cerebral function in the field, for example, synapses in the solution process. Further, it is also possible to various design solutions.

Accordingly, the virtual reality device can activate the design-related cerebral function of a user and can enlarge the region.

Similarly, the virtual reality device can use this technology for the sports field or learning consulting, and can periodically provide the result to the user through brain wave analysis.

The virtual reality device can focus all fields that a user wants by setting user-fit information. The field may include not only a game, but mathematics, English, foreign language, Baduk, music, chess, cooking, relationship with the opposite sex, entertainment, amusement, memorizing, analysis, art, computer, beauty, architecture, etc., and is not limited thereto.

When the virtual reality device determines that a user wants to date with the opposite sex on the basis of a brain wave or analysis of artificial intelligence, the virtual reality device can match people corresponding to the ideal type, that the user wants, with the user.

When different sexes look for a counterpart, their virtual reality device can automatically search and match them by transmitting/receiving signals.

The matching condition may be subdivided into the race, nationality, time for meeting, the age, property, the school career, the body sizes, etc., but is not limited thereto.

The virtual reality device can make match the hobbies of different users or make users take part in a discussion about a specific subject. Further, the virtual reality device can construct a virtual personal space for a user, invite another user, and acquire information about the visitors.

The virtual personal space is used like a one room or a house, so another person may have to make a signal such as a knock, the virtual personal space may be used as an exhibition room such as a blog, a mini homepage, a virtual gallery, etc., and it is possible to know visitors.

The virtual reality device can find out whether another person likes, respects or ignores, or prizes a user by analyzing the facial expression, voiceprint, brain wave, etc. of the another person. This may be used not only for dating, but also the relationships between friends and business counterparts. In this case, it is possible to digitize the degree of feeling in certain percent and receive the value from another person or it is possible to transmit the feeling of the user to the other person.

The virtual reality device can convert the thoughts of a user into texts or typing the thoughts, and can transmit them using a voice, by analyzing brain waves of the user.

The virtual reality device can provide necessary information on the basis of videos of the body of a user or another person. For example, it is possible to health information, necessity of diet, diet information, etc.

Further, when a user gives a search order for a specific purpose, it is possible to give help to the user for example by analyzing and providing the features of users who are over the average weight in accordance with the order.

When a user thinks of wanting to eat specific food, the virtual reality device can provide relevant information and advertisement to the user by analyzing brain waves of the user. Further, it is possible to automatically order food that a user wants or food corresponding to provided advertisement.

The virtual reality device can perform ordering, purchasing, purchase recommending, and receiving a proposal from the service provider for not only food, but also all kinds of products that a user wants by reading out thoughts of the user. For example, the virtual reality device can manage the fields of book, music, electronic product, clothes, shoes, cosmetics, car, travel, learning, exercise, finance, medicine, etc., and can manage all fields without being limited thereto. For achieving the technology, the virtual reality device can be connected with all brain wave-related devices including a wireless device.

The virtual reality device learns a signal pattern of a brain wave that is detected before a user makes a specific action, thereby being able to expect the specific action and perform a corresponding function before the user makes the specific action. For example, it is possible to turn on a computer even before a user presses a computer button. The virtual reality device not only can expect an action of a user, but can determine an order corresponding to an expected action of a user on the basis of the logical connection with surrounding objects. In this case, it is possible to perform an order in consideration of an external 3D environment existing in a space together with the action pattern and the biological reaction of the body.

The virtual reality device can control videos in various ways such as enlarging, reducing, and moving a real image or a virtual reality image up/down and left/right, adjusting the size of the image, turning over pages of a book, and performing zoom-in/out.

The virtual reality device can simultaneously show a fingernail, a palm, a fist, a finger, both hands, various hand shapes, etc. in a virtual reality image, and can recognize a target or a purpose in accordance with movement of user's hands. When a user tries to touch, indicate, or catch a specific target in a virtual space, the virtual reality device can move the target in the virtual space or the entire image toward the user in accordance with movement of the hand so that the user can more quickly indicate or catch the target with the hand. After this operation, the image can be returned into the initial state.

The virtual reality device can sense movement of all parts of a human body including not only hands, but also the eyelids, the whites, the irises, and the pupils and can use various input methods including a brain wave without limitation.

The virtual reality device may recognize the hands of other people in a crowded space when recognizing the hands of a user. In this case, it is possible to give different colors to the hands of the user and the hands of other people or separately recognize the hands, and it is possible to classify the hands such that control is not performed by the others' hands.

When another person peeps at an image of a user, the virtual reality device can sense the gaze and can color the gaze in the image or give notification to the user. Similarly, the virtual reality device is discriminated not to be controlled by the gaze of people other than a user.

In an embodiment, the virtual reality device can recognize the pupils of another user other than a main user and can trace movement of the pupils. When recognizing that another user looks at an image, the virtual reality device is automatically turned off, thereby being able to perform a security function.

The virtual reality device memorizes brain wave patterns that are shown when a user thinks of a desired image that the user wants, such as a user's dream, a person that the user misses, and an imagination of the user, and returns the same brain wave to the brain, thereby being able to help the user to have a desired dream. Further, it may be possible to adjust and use a brain wave pattern to fit to an opposite phenomenon or the purposes of other necessary places.

The virtual reality device can make brain waves that are measured in the normal life of a user into a database by operating with a wireless device. The virtual reality device can acquire the personal behavior and a corresponding brain wave map by analyzing the pattern. When the virtual reality device is connected to another device, etc., the virtual reality device can give an order with reference to the personal behavior and brain wave map and can acquired the acquired brain wave map from the another device and provide a personalized service to the user.

The device that measures the brain waves of a user in accordance with the disclosed embodiment may include glasses, an earring, a wig, a headband, a hair band, and an (hair) accessory, a device operating with the device described above may have the type of a cell phone, a bracelet, a watch, a ring, necklace, clothes, a shoe, a waistband, a bag, various accessories, a hat, a badge, a glove, a sock, an artificial fingernail, a wallet, a contact lens, a pillow, a necktie, a scarf, a necktie pin, a buttonhole, a band, etc., and the brain wave amplifier may have a type that can be attached to several parts of a body, including the devices described above. Other than these devices, various types and kinds of devices may be used together or separately.

The virtual reality device can remove other signals that are not the object that a user concentrates on, even though the brain waves of the user are amplified.

The virtual reality device can configure and show image of the normal life taken before, a combination with a video, and an image corresponding to the actual memory by analyzing the brain waves related to the memories of a user. Further, it is possible to provide information that can be a seed such as pictures of the pas, and then make recalled memories of a user into a video by sensing and analyzing the memories.

The virtual reality device can record that brain waves of a user changes, depending on situations or time, can learn the changes, and then can determine similarity between brain wave patterns on the basis of the changes even though the brain waves slight change. Accordingly, the virtual reality device can increase the recognition ratio of orders corresponding to the brain waves of a user and can increase the accuracy of the entire order system on the basis of the recognition ratio.

The method in which the virtual reality device acquires an order for adjustment from a user is various, but for example, the following embodiments may be applied.

For example, the virtual reality device can acquire an order for operating an external device by recognizing movement and shapes of fingers of a user. Further, the virtual reality device can acquire user input by recognizing a voice of a user, recognizing movement of the whites, the eyelids, the brain wave, and the pupils of a user through a camera disposed therein, or recognizing movement of the head of a user.

In an embodiment, the virtual reality device can recognize the fingernails of a user beyond recognizing fingers. For example, the virtual reality device can recognize the locations of fingernails of a user on the basis of at least one of the shape, color, and feature of the user's fingernails, can recognize at least one fingernail from a taken video, and can acquire user input on the basis of the location and movement.

When the virtual reality device recognizes the locations of the fingernails of a user, the virtual reality device trace movement of the user's fingernails. Accordingly, even if a user turns over a hand or folds fingers such that fingernails are not shown, it is possible to estimate the location of the user's fingernails on the basis of the previous movement and locations. Accordingly, the virtual reality device can acquire user input according to movement of the user's fingernails.

In an embodiment, the virtual reality device can initially request a user to show at least one fingernail of both hands or one hand. For example, a user wears the virtual reality device and opens both hands in front of his/her eyes such that the backs of the hands are photographed. In this case, the virtual reality device can estimate the locations of the fingernails of the user even though the user has any shape of hands by acquiring the features of the hand and the fingernail shapes of the user and starting to trace the locations of the fingernails.

Further, the virtual reality device can acquire user input by recognizing the locations and movement of various objects other than a finger, a hand, or a fingernail.

For example, the virtual reality device can recognize a specific object such as a ring, a watch, or a fit of a user and can use the specific object to acquire user input.

In an embodiment, the virtual reality device can determine an article to be used to acquire an order in accordance with selection of a user. For example, the virtual reality device can acquire user input by tracing the location and movement of an article indicated by a user in a video.

In another embodiment, the virtual reality device automatically selects objects having features, which can be easily traced, from the body of a user and articles that the user wears, traces the locations and movement of the selected objects, thereby being able to acquire user input. The virtual reality device can induce the user to intentionally perform input using a specific object by transmitting the information about the selected objects to the user.

In an embodiment, the virtual reality device can acquire a brain wave of a user using the method described above, can acquire user input using the brain wave, and can control an external device.

The method of acquiring input according to movement of a user may be used to provide various kinds of simulations. For example, the virtual reality device can provide practical experiences such as virtual driving, assembling, and manufacturing to a user on the basis of a virtual reality video and input by movement of the user. For example, when using fingernail recognition, since it is possible to determine movement of the hands of a user under a low load, it is possible to easily provide various practical experiences to the user.

In an embodiment, the virtual reality device may be used with a drone.

For example, a small drone may be configured to photograph a user while following the user wearing the virtual reality device over the user's head by communicating with the virtual reality device.

Accordingly, the user can record and check his/her location, movement, and daily life not only at a first-person point of view, but also in a third-person point of view. The user can change the distance or direction of the third-person point of view by controlling the location or altitude of the drone.

For example, when a user moves his/her body while looking at himself/herself in various direction such as over or in front of his/her head at a third-person point of view, the user can control his/her movement like a main character having a third-person point of view in a game. Accordingly, it is possible to provide various entertainment services by combining this function with a survival game, an augmented reality, a mixed reality game, etc.

Further, this function can be used for athletes to correct their movement or forms in real time by looking at their conditions at a third-person point of view.

In an embodiment, the virtual reality device can create a video with a point of view different from the point of view of the actually taken video. For example, the virtual reality device can create a video of the front that is like being seen at a higher angle, and can display the created video as a virtual reality video. In this process, the virtual reality device can digitalize a video and perform rendering on an image seen at another angle.

The drone that is used in the embodiment described above may be small like the size of a ping-pong ball. However, it is apparent that the size of the drone that is used in the embodiment described above is not limited thereto.

Further, the drone that is used in the embodiment described above may have a protective case for preventing damage or an injury of a user due to a fall. For example, the protective case may be configured in a spherical shape that can accommodate the drone and is made of a net to be able to pass air.

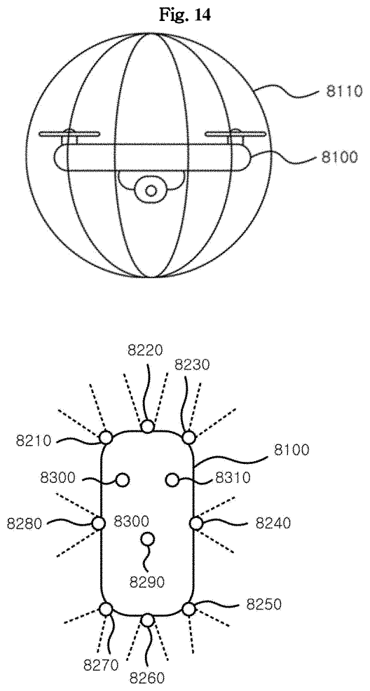

For example, referring to FIG. 14, a drone 8100 and a protective case 8110 accommodating the drone 8100 are shown. However, this is provided as an example and the shapes of the drone 8100 and the protective case 8110 are not limited thereto.

In an embodiment, the drone 8100 or the protective case 8110 accommodating the drone 8100 includes at least one light source so that the location of the drone 8100 can easily found out even in a dark place.

In an embodiment, the virtual reality device can display a video taken by a drone at another location as a virtual reality video by operating with the drone. For example, the virtual reality device operates with a drone at an overseas tourist resort and the drone transmits a video of the tourist resort to the virtual reality device while moving in accordance with the movement speed and direction of the virtual reality device. The virtual reality device can display the received video of the tourist resort as a virtual reality video. To this end, a drone lender who lends a drone that can operate with the virtual reality device may be required at the tourist resort. The drone lender can receive a request for renting a drone through a network and can lend a drone when payment is finished.

Further, the drone according to the disclosed embodiment has an automatic navigation function, and accordingly, when determining that there is an obstacle or another drone within a predetermined distance from itself, the drone can avoid them not to collide or move in another direction. For example, the drone can fly while maintaining a state in which another object does not exist in a predetermined safety distance. The drone can automatically keep a predetermined distance from a user and can fly while recognizing the location of another person and avoiding the route of the person.

In an embodiment, the drone 8100 may further include a plurality of camera modules 8210 to 8310 that can take pictures up and down and in four directions. For example, the drone 8100 may include a plurality of cameras 8210, 8220, and 8230 that can take pictures of the front at a wide angle, a plurality of cameras 8250, 8260, and 8270 that can take pictures of the rear at a wide angle, a plurality of cameras 8240 and 8280 that can take pictures of the sides at a wide angle, and cameras 8290, 8300, and 8310 that can take pictures of the upside and downside of the drone. Accordingly, the drone 8100 can take pictures up and down and in four directions without turning or turning over. The positions and number of the cameras in the drone 8100 are not limited thereto and more cameras may be disposed at various different positions.

The virtual reality device according to the disclosed embodiment can also perform a function for life convenience. For example, the virtual reality device takes a picture of a portion of a house or a room, and can control a robot cleaner to automatically clean a dirty part or a part that needs to be cleaned by communicating with the robot cleaner when determining there is a part that is dirty or needs to be cleaned in the taken video. Similar to the embodiment described above, a user can check a video taken by a robot cleaner using the virtual reality device or can transmit a control order for a robot cleaner that is photographed by the virtual reality device or is visually seen.

In an embodiment, the virtual reality device can automatically determine a part that got dirty by comparing a video of a clean house and a video of taken of the house.

The virtual reality device can display visualized information by recognizing and determining a contaminated part of the floor or the air in a current real space (e.g., a house or an office) and by reflecting the sanitation state or the degree of contamination of the real space also to a virtual space or a synthetic space. A user can determine places to be cleaned or the seriousness of contamination on the basis of the displayed information.

Further, an ultra-mini waterproof sensor is attached to at least a portion of various fiber products such as clothes, socks, a pillow, underwear, and a hat, whereby it is possible to determine the degree of contamination of parts of which the degree of contamination is difficult to determine due to the colors of clothes, etc. or it is possible to determine whether parts that a user usually has difficulty in recognizing such as the back of the neck have been contaminated. The virtual reality device can provide the humidity, the degree of contamination, the density of bacteria, etc. at each part, using a sensor attached to a fiber product, can provide information about the point in time of washing, the positions to be washed, and the washing method, and can operate with a laundry machine.

Further, the virtual reality device can determine the location of an obstacle that did not exist before on the basis of a video of a house taken before or a map of the house stored in a robot cleaner, on the basis of a video of a house or a room that is taken. The virtual reality device can control the robot cleaner to perform cleaning while avoiding new obstacles by transmitting the locations, sizes, and shapes of the obstacles to the robot cleaner.

Further, a user can specify the location of an obstacle using the virtual reality device or can control the robot cleaner to avoid a specific location by setting a virtual obstacle or limited space.

Further, the virtual reality device can sense the sound of harmful insects such as a mosquito or a fly and can control a small drone or robot to catch the harmful insects. The drone can attack harmful insects using an electrical shock and can display a video taken by a camera on the drone on the virtual reality device, so a user can have experience like he/she traces and attacks harmful insects on the drone.

In an embodiment, a small drone or robot can determine the location of a harmful insect by itself and can automatically attach or catch the harmful insect.

Further, the virtual reality device can sense the degree of contamination of surrounding air and guide a user to a clean place with relatively low air contamination. Further, the virtual reality device can visualize and provide the sensed components of air or the location of a contaminant to a user.

Further, the virtual reality device can acquire information about the density of ozone in the air, the current state of light (e.g., the density of ultraviolet rays) other than air contamination and can visualize the acquired information using a virtual reality video.

Further, the virtual reality device can control the operation of an air purifier in accordance with the degree of contamination of surrounding air by communicating with the air purifier. Further, the air purifier may have a power device, so the virtual reality device can move the air purifier to a place with contaminated air and can control the operation of the air purifier to purify the contaminated air.

Further, it is possible to sense dangerous factors in the air such as carcinogenic substances, atopy-causing substances, or the like, can purify the air by controlling a ventilation fan, an air purifier, an air conditioner, a humidifier, or a dehumidifier, and can guide a user to a clean area.

Further, the virtual reality device operates with one or more cameras installed in a house, and an IoT system, thereby being able to observe the house photographed by the cameras and can control home appliances in a virtual reality image. For example, when a control panel of an air conditioner in a virtual reality image is operated, the air conditioner actually in a house can be controlled. The cameras installed in a house move or rotate in accordance with movement of the whites, the irises, the eyelids, the pupils, or the head of a user, thereby being able to make a user naturally observe the house in a virtual reality or move. Obviously, it is possible to perform various functions such as necessary control, for example, turning on/off the home appliances, and cooperation of home appliances by operating with the IoT system without a camera.

Further, when a moving object that is not set is photographed or sensed in a house, the virtual reality device of a user can receive information and display the state inside the house.

Further, when the virtual reality device is installed in a house or residence space, the virtual reality device can sense gas using a gas sensor therein and can display the location or shape of the sensed gas on the virtual reality device.

In an embodiment, the virtual reality device can display a virtual password input image. For example, the virtual reality device displays a virtual keypad having randomly rearranged numbers on the keypad of a password door lock by operating with the password door lock.

A user inputs a password using the virtual keypad displayed in the virtual reality video, the virtual reality device transmits the input password to the door lock, and the door lock unlocks the lock when the received password is correct. Alternately, the virtual reality device transmits information about the positions of the numbers of the keypad having randomly rearranged numbers to the door lock and the door lock can acquire a password that a user inputs using the positions of the numbers of the keypad.

In this case, even if another person peeps at the user pressing the password or takes a picture using a camera, etc., the person cannot know the arrangement on the virtual keypad, so security is maintained.

Further, it is also possible to make user input a password by displaying a virtual keypad having not only numbers, but also various symbols or characters regardless of the keypad of the actual door lock.

Further, it is possible to more various patterns of passwords using not only the password, but also a hand action or a gesture of a user, using the virtual reality device. For example, various combinations, for example, limiting the shape of the hand that inputs a password and making a user take a specific hand gesture after inputting a password, are possible.

In an embodiment, the virtual reality device can specify at least a portion of a video taken along a gesture of a user, recognize objects included in the specified part, search the information about the recognized objects, and provide the result. For example, the gesture of a user may include an action that draws a circle or selects a specific object with a hand, but is not limited thereto.

Further, the virtual reality device can recognize a voice of a user and can recognize an object corresponding to the voice of the user in a video that is taken. For example, when it is recognized that a user says “tree” while looking at a side, the virtual reality device selects an object corresponding to a tree in a video that is taken.

In an embodiment, the virtual reality device may operate with bedclothes including a bed or a quilt. The virtual reality device can determine the degree of deep sleep, the degree of fatigue, a sleep time, a biorhythm, or a weight change of a user by analyzing the sleep pattern or the type of a bed of the user. The virtual reality device can make a pleasant bed by controlling temperature, wind, or smell or playing music to induce deep sleep of the user on the basis of the determination result.

The virtual reality device can convert the voice of a user into characters and can read out and convert the shape of the lips of a user into characters or a voice. That is, it is possible to convert only the shape of lips into characters and a voice signal too without actually making a sound. To this end, the virtual reality device may have one or more sensors at positions where it is possible to see lips, and can refer to the shape of the lips of a user for learning and implementing a technology.

The virtual reality device can perform personalized learning on the basis of the way of talking or a habit of a user.

In the embodiment relates to a bed system, sensors and analysis modules may be included in not only a bed, but also in various bedclothes such as a pillow, a mattress, and a cover. Further, a battery and a heating device may be included in bedclothes such as a quilt, a cover, a pillow, and a mattress.

Further, the virtual reality device can check dust in a bed and bedclothes such as a quilt, a pillow, and a mattress. Further, it is possible to whether there are ticks, worms, parasites, etc. The virtual reality device or the bed system can sterilize and disinfect the bed on the basis of the checking result.

Further, a module for performing a voice recording function may be included in the bed and the bed may generate perfume. The voice recording function may be performed only when a user talks, and may be used to analyze snoring or breathing of a user while the user is asleep.

A device for analyzing the brain wave of a user and providing a wavelength that is good for sleep may also be included in the bed. Further, the bed can measure or estimate and provide snoring, breathing, tossing and turning, mouth smell, the degree of aging of the skin of a user, using several sensors. The virtual reality device can share various items of information such as sleep time and a sleep pattern that can be collected and are collected from the bed with a hospital, etc. The bed may include an oxygen generator that can be used during sleep.

In an embodiment, a bed or bedclothes (a quilt, a pillow, etc.) include at least one sensor, can monitor the sleep state of a user such as temperature, the pulse, a breathing sound, and a voice using the sensor, and can transmit the monitoring result to a third person. The information transmitted to the third person can be stored or can be output in accordance with a request from the user. Further, when it is determined that a user is in an emergency situation, it is possible to transmit an emergency message to a third person, a hospital, 119, etc.

In an embodiment, the bed includes at least one sensor for recognizing movement of a user. The virtual reality device can determine movement of a user using the at least one sensor of the bed, and can determine that the user is asleep and turns off surrounding home appliances when the user does not move or finely moves.

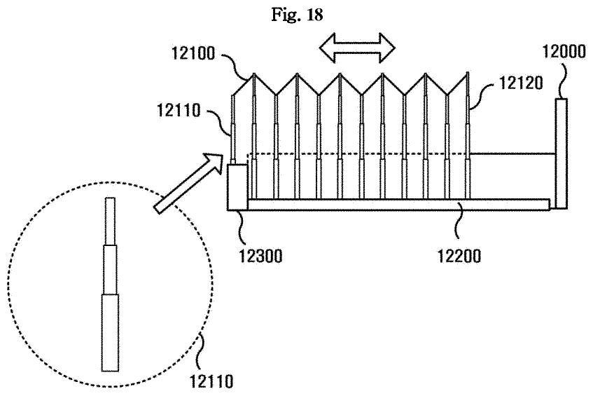

FIG. 18 is a view showing an artificial intelligence bed according to an embodiment.

Referring to FIG. 18, a bed 12000 is shown. The bed 12000, in accordance with the disclosed embodiments, can sense the brain waves of a user and can give help to healthy sleep of the user by sensing the sleep pattern of the user. In this specification, all embodiments described in relation to a bed can be applied to the bed 12000 shown in FIG. 18.

Referring to FIG. 18, the bed 12000 has a sliding blind 12100.

The sliding blind 12100 is configured in a structure that can surround the bed 12000 by folding or sliding, depending on situations.

In an embodiment, the sliding blind 12100 has the function of a blackout shade and enables a user to sleep in a dark space even in the daytime.

In an embodiment, the sliding blind 12100 has a soundproof function, can prevent a sound or noise from the bed 12000 from leaking outside, depending on situations, and, in contrast, can prevent external noise from coming to the bed.

In an embodiment, the sliding blind 12100 can function as a mosquito net.

The sliding blind 12100 has an effect of keeping warmth and coldness other than the above functions, and can surround the bed 12000 by sliding, if necessary, although it is folded when it is not used.

In an embodiment, the sliding blind 12100 is configured in a bellow type, is folded and stowed in a deposit part 12300 disposed at a side of the bed when it is not used, but can cover the bed 12000 by vertically folding and then folding along guide rails 12200 when it is used. When the opposite process may be applied when it is not used.

Further, bars 12110 to 12120 that move up and down and support the sliding blind 12100 has a sliding structure that enables the sliding blind 12100 to fold, as shown in FIG. 18, after folding toward the deposit part 12300. Accordingly, the bars can be moved to the lower end of the bed with the bellows and can be folded and stowed in the deposit part 12300 at a side of the bed when they are not used.

The sliding blind 12100 can be manually folded or unfolded, and can be moved up from the lower end automatically by various means such as an actuator that uses hydraulic pressure or pneumatic pressure, and then can be electrically unfolded by a motor.

In an embodiment, the bed 12000 may be equipped with at least one infrared sterilizing module, which can be used to keep the bed sanitary.

The virtual reality device can sense impure air inside or outside a room and can automatically open/close a window. Further, it is possible to operate and control a ventilation fan, an air purifier, etc. Further, when an alarm is provided, an audio system, a TV, a light, etc. may also be operated and controlled.

Further, a mood light, a fluorescent light, or the like can be operated and controlled with the virtual reality device, can be controlled by a voice order, can automatically change to be slightly dark when a user drinks, can brighten the surrounding of a desk when a user studies, and can darken when a user watches TV, whereby they can be controlled in various ways.

The virtual reality device can determine whether to put or take food into or out of a refrigerator, whether there is smell, whether to open the refrigerator, and whether food has spoiled rotten by operating with sensors in the refrigerator.

The virtual reality device can control the temperature around food in accordance with the kinds of food in a refrigerator.

The virtual reality device can awake a user by turning on a light or providing exorcism information, voices, songs, etc. when a user has bad dream, by installing a chip in the brain of the user and connecting the chip to the virtual reality device. Other than a chip installed in the brain, various members having various brain stimulation devices such as a pad and a pillow that are attached to the head may be used. The brain stimulation device can not only sense brain waves, but also transmit an input brain wave to a brain.

The virtual reality device is connected with a wireless earphone, and can perform a function of inducing the user to have a good dream by transmitting a sound and a voice, perform learning, and analyzing brain waves when a user wears the wireless earphone while sleeping.

When information about an important disaster, an item of news, news, notification, etc. are transmitted to a user even though the virtual reality device is turned off, the virtual reality device can be automatically booted and can display a relevant image.

The virtual reality device may be manufactured for animals. For example, it is possible to make a puppy feel like playing or walking with other puppies with a VR device on. The shape and position of the virtual reality device needs to be adjusted in accordance with the positions of the eyes of a puppy. Similarly, the shape can be changed in accordance with the shape of the face of a puppy and a lead of the puppy may be used as a band for the virtual reality device.

Similarly, when a user virtually touches a specific position in cooperation with an image, it is possible to provide the sense of touch. To this end, peripherals such as a specific glove or whole body suit may be used. The whole body suit may be made in various types such as clothes, synthetic resin, metal, synthetic rubber, a synthetic material, an artificial skin In an embodiment, the virtual reality device can provide the sense of touch as if different users interact with each other at remote distances using the devices described above. For example, when users at different locations shake hand with each other win a virtual space with a controller, which is a whole body suit or glove type, on, the sense of touch of shaking hand, pressure, etc. can be transmitted to the users through a controller.

In an embodiment, the whole body suit may be configured in a structure that can cover even the neck and the face of a user. Accordingly, the user can feel various experiences such as the sense of touch for each part and various strength adjustments depending on an image such as tightening, hitting, massage, vibration, hot/cold experience, pumping, and electrical experience.

In an embodiment, the glove type controller may be configured in a type similar to a disposable vinyl glove, has one or more position sensors and various sensors such as a touch sensor as components, and is wirelessly connected with a virtual reality device. Further, the controller can assist a user to input various gestures by recognizing find hand actions of the user.

Further, when the glove type controller is made of a durable synthetic material, it is possible to provide various stimuli such as coldness, an electrical stimulus, pricking, warmth, and wind to a user through the glove type controller, and a device for expressing the stimuli may be provided.

Further, the virtual reality device can provide hand acupuncture or moxibustion treatment based on oriental medicine information using the glove type controller.

Further, when a user holds a specific article in a real space with a hand with the glove type controller on, the virtual reality device can insert and display the article in a virtual space.

The glove type controller is provided as an example, and other than the glove, various types of controller such as a sock, a shirt, underwear, and various clothes may be provided and used to perform the embodiment described above. In order to implement the technologies, consensus, the sense of touch, etc. of interaction can also be provided through a robot or a doll.

A religious mark may be provided on a side of the virtual reality device, and it is possible to put a luminous or LED mark, an advertisement mark, etc. on a sliding side, thereby being able to make the device be conspicuous even at night and achieve an advertisement effect.

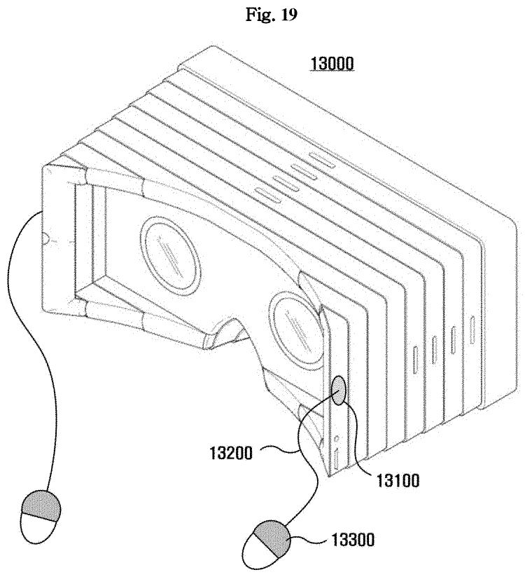

FIG. 19 is a view showing a virtual reality device with built-in earphones according to an embodiment.

Referring to FIG. 19, a virtual reality device 1300 may have earphone deposit parts 13100 in double side walls. The earphones 13300 are taken out of the earphone deposit parts 13100 and earphone lines 13200 are rolled in the double walls of the virtual reality device 1300, and can be taken out with the earphones 13300 when a user pulls the earphones 13300.

In an embodiment, a microscope, an endoscope, or a camera may be attached to the ends of the earphones 13300. The virtual reality device can take pictures of several parts of the skin of a using them and can photograph and determine a skin disease of the user or diseases at the back of the head, at the neck, and inside the ears of the user.

Further, the virtual reality device includes a Norae Bang microphone and can provide a virtual Norae Bang microphone service to a user. The Norae Bang microphone may be provided inside the cover of the virtual reality device or may be rolled in the double wall like an earphone.

In an embodiment, the virtual reality device can share wind, temperature, smell, humidity, an electrical stimulus, a touch stimulus, etc. in a virtual Norae Bang with a wearable device or can independently use them, and can operate with videos corresponding to the songs, lyrics, and voices in the virtual Norae Bang. For example, the virtual reality device can control the surrounding environment of the virtual Norae Bang to be suitable for the contents (lyrics) and moods of songs. Further, it is possible to play videos that are suitable for songs and lyrics and can control the environment of the Norae Bang to correspond to the videos. Further, the Norae Bang microphone may be connected wirelessly to the Norae Bang systems and peripherals. In this case, the Norae Bang systems that can include microphones may be equipped with a temperature controller, and smell, electrical stimulus, and touch stimulus devices.

In an embodiment, the virtual reality device can find out and provide a song that a user wants by recognizing the user humming or singing a partial section. For example, the virtual reality device can reserve a song corresponding to a humming voice of a user.

In an embodiment, when it is difficult to specify a song only from a humming sound of a user, the virtual reality device can narrow the search target range on the basis of the songs that the users frequently sings or frequently listens, and can select a song corresponding to the humming of the user.

In an embodiment, the virtual reality device can find out a song that a user is looking for, on the basis of the face and voice of the singer, a melody, lyrics, a background, a rhythm, a title, etc. that correspond to the music that the user thinks of, on the basis of brain waves of the user.

Further, it is possible to output an assistant voice using the voice of a user while removing the actual voice of the user for high notes, a fast rap part, difficult foreign language lyrics that the user has difficulty in singing.

In an embodiment, the virtual reality device can arrange or change a sing, which is heard from a Norae Bang or the streets, into another genre and provide the song to a user.

When a user plays billiards in a real or virtual space, the virtual reality device can provide information about the hitting point, angle, etc. of a billiard ball, and accordingly, can display the path that the billiard ball can move. Accordingly, it is possible to record the movement of the ball that a user actually hits, and can provide feedback by comparing the movement with the provided information.

The virtual reality device can operate with a billiard tool (e.g., a cue) that operates with a virtual image and provides a position, speed, intensity of power, an angle, and action pattern using a real space image and a sensor attached to a real cue, and one or more sensors that can find out the position, shape, movement, speed, and direction of people. Further, it is possible to acquire information about a jumping power, a speed, a directions sense, an attack ability, a defense ratio, etc. Accordingly, the virtual reality device can be combined with a virtual billiard system. The virtual reality device can control the viewpoints of a user in various ways. For example, a user can be a ball and have a 3D collision experience.

Further, the virtual reality device can change and provide the gaze of a user to the ground, the air (bird view), etc. in various ways in real or virtual sports, and can provide videos with gazes corresponding to the location of a player at each position and the positions of judges. In a rear sports video, players and judges can play the sports with cameras on. Further, the virtual reality device can change the viewpoint of a user into the viewpoint of a giant or a pigmy and can increase or decrease the volume of things such that the things are reduced for the viewpoint of a giant and are enlarged for the viewpoint of a pigmy. Further, the virtual reality device can change the viewpoint of a user into viewpoints based on the positions and movement ways of other animals such as a fly, an ant, a dog, and a cat such that the user experience the viewpoints of the other animals.

Further, the virtual reality device can analyze and provide movement of a user or players, corresponding records and results. Further, it is possible to provide movement of a user or players in a slow motion or can analyze peculiar behaviors of the players. For example, it is possible to provide an attack method or inform a user or players of improving plans by analyzing their routines (cliché).

The virtual reality device can provide experiences of various virtual sports. For example, when it is volleyball, it is possible to provide an experience using peripherals such as a glove. When it is tennis, a tennis racket can operate with a virtual tennis racket, so it is possible to enable a user to virtually play tennis on the basis of the hitting point on the racket, the speed of the user, the angle of an arm, the attack target, accuracy, physical strength, jumping power, etc. When implementing the functions described above, it is possible to observe actions of a user and analyze the pattern at the position of the viewpoint of a third person, and can correct and supplement the actions and techniques of the user through a video mixed with a model. That is, in order to implement the functions related to various sports other than tennis and golf, as described above, a system that performs observation and provides feedback at the viewpoint position of a third person may be provided.

The virtual reality device can display a synthetic space in which a virtual space and reality are mixed. When a user controls a specific electronic device in various ways such as pushing, touching, pressing in a synthetic space, the virtual reality device can control the corresponding real electronic device in the same ways. Further, various factors such a brain wave, a gesture, biological information, etc. may be used for the control.

Further, the synthetic space may be involved with a real space other than an electronic device.

For example, when a user pour water into a cup as much as a predetermined amount in a virtual space, it is possible to pour water in a real cup in the same amount by operating with a water supplier that actually exists.

When a user walks on sands, a gravelly field, or a slope in a virtual reality space, a shoe or foothold type peripheral that makes the user feel like actually walking on them may be used. Further, when a user actually walks on a gravelly field, it is possible to transmit the feeling to another person and it is also possible to keep the feeling to experience it again later.

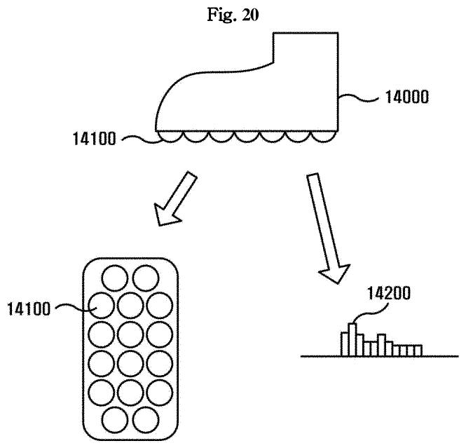

FIG. 20 is a view showing a virtual reality experience shoe according to an embodiment.

Referring to FIG. 20, a virtual reality experience shoe 14000 may have one or more balloon-shaped spheres, into which air can be injected, on the bottom. The virtual reality experience shoe 14000 can make a user feel like the inclination of a surrounding environment changes by operating with a virtual reality device when air is injected into or taken out of the spheres 14100. For example, when air is injected into the front spheres of the virtual reality experience shoe 14000, a user can experience inclination such as an uphill.

Further, small metal needles 14200 may be densely arranged on the floor of the virtual reality experience shoe 14000. The metal needles 14200 can move up and down and can implement the floor state of a virtual reality video displayed by the virtual reality device by operating with the virtual reality device. For example, when the floor of a virtual reality video is composed of small stones or may be a gravelly field or a concrete floor, the metal needles 14200 protrude from the floor of the virtual reality experience shoe 14000, thereby being able to form prominences and recessions having the corresponding sizes. In this case, various actuators may be used and the metal needles may be multi-stage foldable sliding screen barrels with a closed top and pneumatic or hydraulic outlets on the lower ends. Further, a touch transmission device that transmits the sense of touch may be disposed on the insole. Accordingly, a user can have experience like walking an environment displayed by the virtual reality device with naked feet.

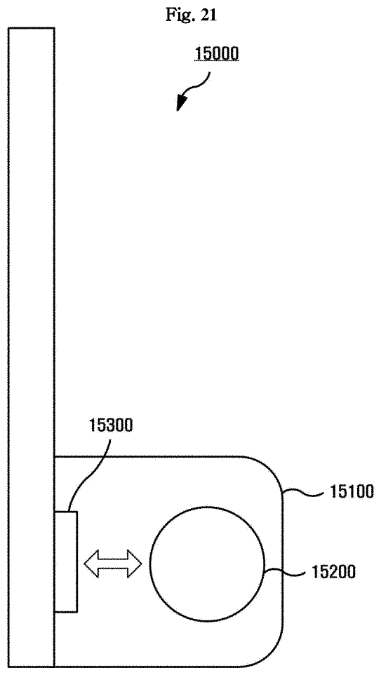

FIG. 21 is a view showing a virtual reality experience golf club according to an embodiment.

Referring to FIG. 21, a golf club 15000 may be used to play a virtual golf game by operating with the virtual reality device.

A gold ball 15200 may be disposed in the head 15100 of the golf club 15000. The golf ball 15200 may be different from the golf balls that are actually used in golf.

Depending on embodiments, the golf ball 15200 may be formed in various shapes such as a cylinder or a cube other than a sphere.

Further, an electromagnet 15300 may be disposed in the head 15100 and an electromagnet may be disposed in the golf ball 15200 too.

In an embodiment, the electromagnet 15300 and the gold ball 15200 may be configured to have the same polarity on the sides facing each other so that they cannot come in contact with each other due to the repulsion.

When a user swinging the gold club 15000 is recognized, the golf club 15000 blocks the current flowing in the electromagnet or giving different polarities on the sides facing each other of the electromagnet 15300 and the golf ball 15200 such that the electromagnet 15300 or a side thereof and the gold ball 15200 collide with each other in the head 15100 by rotation of the golf club 15000 and the user can feel like actually hitting the golf ball.

The virtual reality device can determine the direction and the flying distance of a golf ball in a virtual golf game in consideration of the rotation speed and direction of the golf club 15000, the shock applied to the golf ball 15200 in the head 15100, etc. by operating with the golf club 15000.

Further, at least one sensor for sensing hitting may be disposed in the golf club 15000 and the gold ball 15200, and the golf club 15000 and the golf ball 15200 can analyze and transmit the hitting point, hitting intensity, rotation, etc. at the moment of hitting to the virtual reality device.

Further, when a sports game is broadcasted, as described above, it is possible to broadcast the game at various viewpoints using cameras attached to players or judges and make expression various by applying colors. Alternately, it is possible to attach a virtual advertisement to a predetermined portion of a player and the virtual advertisement may be different advertisements, depending on people looking at the virtual advertisement. The virtual reality device can provide different expressions such as giving a color so that it is easy to determine the location of a favorite player.

In an embodiment, the virtual reality device can sense a surrounding scene and can create and display a virtual underwater space, which is discriminated from the actual ground or exists in the edge, in a virtual reality image. In this case, the real space corresponding to the underwater space is removed, and even if a user moves, the underwater space is provided as a 3D video like actual nature, in which the underwater space may be replaced with another natural object such as a desert, the space, or lava.

Further, the virtual reality device can fire an arrow in a virtual reality on the basis of the cord of a bow, a pressure, a bending pressure, the sense of touch at firing by operating with a bow or an arrow to which a sensor is attached, and can provide corresponding feedback to a user.

Further, the virtual reality device can provide a virtual reality sword fight game using a sword-shaped controller with a sensor attached thereto. The weight and movement speed of the sword-shaped controller and the length of the sword are reflected to the virtual reality, and feedback according to movement is provided as vibration or a sound to a user. In this case, it is possible to reflect the intensity of the power of the sword by reflecting the grasping power, weight, speed, etc. of the user and the opponent.

Further, the virtual reality device can operate with a refrigerator and the refrigerator can provide appropriate storage temperature for the types of stored food, and can provide notification when the storage temperature is different from the actual storage temperature. Further, it is possible to inform a user of the information about the purchased and stored products, the expiration data of food, a decomposition state, etc. Further, the virtual reality device can show the food in the refrigerator by scanning the refrigerator with the doors closed using a brain wave or connection with a virtual reality. In this case, a camera may be installed in the refrigerator.

The virtual reality device can automatically control the operation time in accordance with the kinds and amount of food by operating in a microwave oven. When gas, etc. that are harmful substances are sensed, it is possible to inform a user of the components and the content and stop the operation. Further, it is possible to analyze the degree of contamination of the microwave oven and provide a cleaning notification function. Further, to this end, a camera or various sensors may be attached. When contents with rubber or a problem are sensed, it may not operate to prevent a fire or malfunction and a camera sensor may be attached to a portion.

The virtual reality device can display the degree of cleanness of a cleaner filter as a level by operating with a vacuum cleaner. For example, the virtual reality device can provide feedback showing how clean a house has been cleaned, and can provide notification for clear out a dust bin of the vacuum cleaner.

The virtual reality device operates with a robot cleaner, can cover noise with music or can make music by mixing noise of the robot cleaner when the robot cleaner make a loud noise.

In the vacuum cleaner, the size of a tube can be adjusted or a net is disposed in the tube to prevent large dirt from being suctioned during cleaning. Further, a sensor can sense the size in advance and stop the operation.

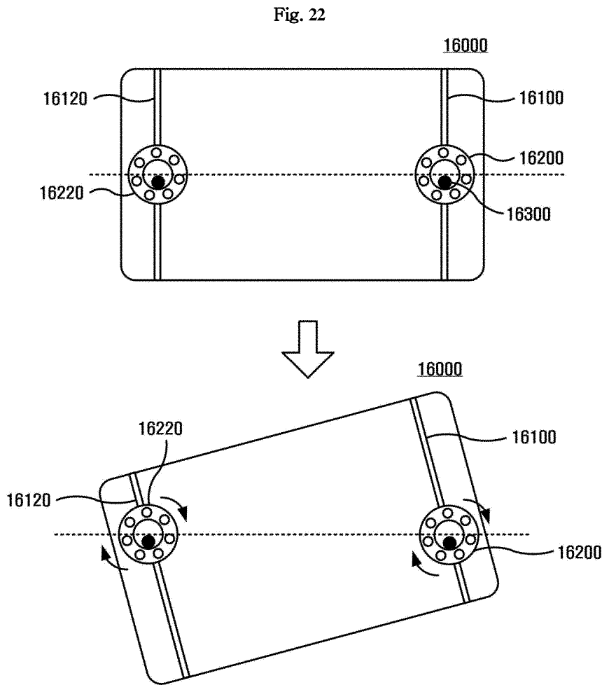

FIG. 22 is a view showing a virtual reality device including one or more movable cameras in accordance with an embodiment.

Referring to FIG. 22 a virtual reality device 16000 includes one or more camera modules 16200 and 16220. Accordingly, by simultaneously taking pictures of two spaces and providing a two-divided image having a predetermined distance and angle, it is possible to provide a real space as an experience environment having the feeling of a VR space.

The camera modules 16200 and 16220 can move on rails 16100 and 16120, respectively. In this case, a motor connected with a gear or a wire, etc. may be added. Further, the camera modules 16200 and 16220 each have a motor connected with a bearing, a lubricant, a wire, etc., a motor connected with a gear, or a rotary member such as a hydraulic rotary member so that the cameras in the camera modules 16200 and 16220 can be rotated.

In an embodiment, the virtual reality device 16000 may include one or more sensors that can measure inclination of the virtual reality device 16000 such as a slope sensor, a horizontal sensor, and a gyro sensor. The camera module 16220 and the other camera module 16200 can operate with each other.

For example, as shown in FIG. 22, when a side of the virtual reality device 16000 inclines downward, the camera module 16220 moves down and the other camera module 16220 moves up, so both of the camera modules can keep horizontality. Further, even if a user faces at an angle over the horizon, both of the camera modules can simultaneously face the horizon, depending modes. Further, the camera modules 16200 and 16220 may be disposed at both ends of the virtual reality device 16000.

Further, the camera modules 16200 and 16220 can rotate right to be maintained at the fixed positions without rotating in the same direction as rotation of the virtual reality device 16000.

Accordingly, the virtual reality device 16000 can stably take pictures even if it is shaken or moved. The virtual reality device 16000 can take and provide two pictures with slight different ranges of field of view as virtual reality images.

In an embodiment, the camera modules 16200 and 16220 each have at least one weight 16300, so even if the virtual reality device 16000 is rotated or moved, the camera modules 16200 and 16220 are not rotated or shaken by the weights 16300.

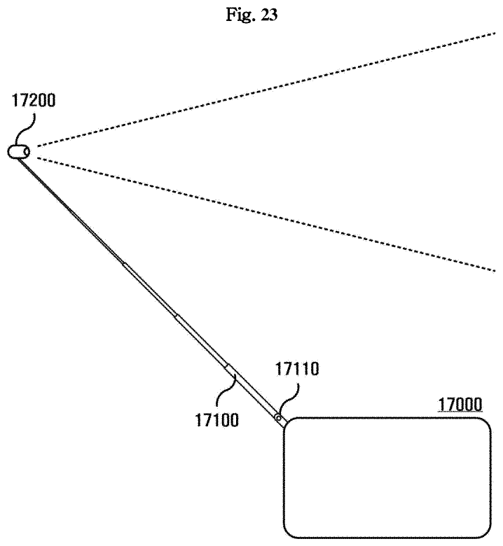

FIG. 23 is a view showing an antenna selfie stick according to an embodiment.

Referring to FIG. 23, a virtual reality device 17000 may include a selfie stick 17100 that can rotate, can bend at a lower end connector 17110, and can stretch like an antenna. A camera 17200 is disposed at the end of the selfie stick 17100 so that a user can take a selfie after securing a sufficient distance from the camera 17200 by stretching the selfie stick 17100 with the virtual reality device 17000 in hand.

Further, the camera 17200 can rotate in different directions and it is possible to insert the camera 17200 into a narrow space, which is difficult to visually see, using the selfie stick 17100 to function as an endoscope.

Further, the camera 17200 may include a flash, and accordingly, it is possible to take pictures of the inside of the mouth or the throat and check the pictures through the virtual reality device 17000.

Further, the camera 17200 can be separated from the selfie stick 17100, and in this case, it is possible to take pictures while remotely controlling the camera 17200 using the virtual reality device 17000 with the camera 17200 at a long distance. For example, a projector is disposed around the camera 17200, so it is possible to output a predetermined image on the floor and adjust the size of the output image. When input is provided or a picture is drawn on the image using a gesture, etc., input corresponding to a display of a corresponding virtual reality device can be received or the picture can be displayed.

The virtual reality device may have a sensor that can measure the blood vessels or the pulse of a user, so it is possible to check safety, danger, warning of the health of the blood vessels, and states such as stress, tension, excitement, anger, pain, anxiety, and calmness, and it is possible to transmit the result to a device that the user's family uses in relation to the actual life. Further, it is possible to warn the user of danger, depending on an external or virtual situation, by accumulating and analyzing these data for a long period of time, and it is possible to give help to health by checking the long-period mental state of the user, combining the mental states with brain waves, and analyzing the reasons.

The virtual reality device can combine and provide the tastes or smells of electronic cigarette in various ways.

The virtual reality device can recognize the size of the pupils, movement and the shape of the eyelids of a user, etc., and particularly when the user is a youth or a child, the virtual reality device can be forcibly stopped so that the user can take a rest to protect the eyesight. Further, when the virtual reality device is used in a close contact state without being extended, a display may not operate when it is not spaced a predetermined distance, for example, 20 cm from the display device. Further, when the state of a brain wave, the size of the pupils, etc., are measured and they are recovered into the initial states or exceed a predetermined level, the operation function can be recovered.

In the disclosed embodiment, when a user unfolds the virtual reality device that has been folded, the virtual reality device can be automatically turned on. Similarly, when a user folds the virtual reality device, the virtual reality device can be automatically turned off.

That is, various sensors such as a camera lens, a luminance sensor, a proximity sensor, a touch sensor, and a motion sensor disposed on a cell phone, a display, or an ocular plate sense that the virtual reality device, particularly, a screen member is unfolded or the ocular plate is moved away from the cell phone or the display, thereby being able to execute various set applications such as an application related to a virtual reality or an augmented reality. Further, it is possible to finish the executed applications by sensing that the screen member is folded or the ocular plate is moved close to the cell phone or the display.

For example, when a user unfolds the virtual reality device, the virtual reality device can be automatically turned on, the default image can be shown, and a video or a game that the user wants to use can be immediately set when a brain wave, a voice, or a lips' shape is used. Similarly, when the virtual reality device is folded, the video can be turned off or the user is logged out of the game, and the virtual reality device can be automatically turned off.

The virtual reality device is used to record the daily life of a user by classifying acquired voices or videos.

For example, like the human brain partially memorizes important events for a day and forgets unnecessary or fitting memories, it is possible to classify information determined as meaningful on the basis of specific reference of acquired information such as a space where a user has stayed for a long time, the voice of an object that the user has talked with for a long time, or an object that the user has looked at for a long time, to keep the meaningful information for a long time in comparison to information determined as relatively meaningless or to immediately delete the information determined as meaningless.

In an embodiment, the virtual reality device can record the daily activities of a user in the type of log or diary. Further, the virtual reality device can inform a user of wrong parts by comparing the diary written by the user as the actual log, and also can set the degree of how minutely it records the diary.

Further, the virtual reality device can arrange information on the basis of another reference. For example, since the conversation with a person who a user frequently meets (who can be determined on the basis of the location, a voice feature, a video feature, etc.) must be mostly normal conversation, it is possible to reduce the ratio of information to be stored. Further, for a person who a user meets from time to time or meets for the first time, it is determined that the possibility of exchanging important information like a business meeting is high, whereby it is possible to increase the ratio of information to be stored. Further, even when a strong impression is required like an intense feeling or a strong reaction of a brain wave pattern, it is possible to increase the ratio of information to be stored.

Further, the virtual reality device can search the recorded contents on the basis of a clue provided by a user. For example, since the memories of human are fragmentary in most cases, when information memorized by human is provided little by little, the virtual reality device can perform searching and assist the memory of a user on the basis of the provided information.

In an embodiment, the virtual reality device acquires the location of a fish (or a group of fishes) or a piece of game (animal) by operating with an artificial satellite or other observation devices and displays the acquired location on the virtual reality device, thereby being able to inform a user of the location of the fish or the piece of game when the user is sailing, hunting, catching fish, or fishing.

In an embodiment, the virtual reality device can determine can determine the kind of a recognized object on the basis of the shape or the pattern of movement of the recognized object. For example, the virtual reality device can determine the kind of a fish or the kinds of fishes in a group of fishes, and can determine the kind of a piece of game (animal) and provide information to a user.

Further, when a statutory epidemic breaks out, the virtual reality device can acquire the information of relevant organizations, and can acquire and provide the information about the location of surrounding infected people, the distances from infected people, the density of infected people in each area, etc. Further, the virtual reality device can check the location of hospitals and the capacities of the hospitals in accordance with the kind of the epidemic and can display them on a map or automatically give a user a briefing of the situations.

Similarly, the virtual reality device can acquire and provide information about the location together with information about a person with a dangerous weapon or the kind of the weapon. For example, the virtual reality device can acquire terror information and provide information about surrounding dangerous weapons by operating with an external system. This information may be provided by a government system, but in some case, the virtual reality device can scan surrounding dangerous weapons using at least one camera or sensor and then provide information according to the scanning result.

For example, when a person escape from a fire site or a firefighter who is rescuing a person wears the virtual reality device according to the disclosed embodiment, it is possible to determine or avoid the location of a fire that is not visually seen, or extinguish the fire and it is possible to know the temperature beyond an aisle, so it is possible to prevent a dangerous situation such as a backdraft.

Further, when the virtual reality device acquires a video of the sign of a restaurant, it is possible to check the number or positions of vacant seats in the restaurant and to display the menu by operating with a system in the restaurant. A user can make a reservation at the restaurant or can order menus in advance using the virtual reality device. The virtual reality device can transmit the information of the current location so that they can cook the food on time of arrival.

In an embodiment, the virtual reality device can acquire the information about a store that a user is looking for, can acquire the location of the store, and can create and display a virtual reality video in which the store that the user is looking for is shown large a shown bright or only the store that the user is looking for is shown. For example, when a user is looking for a Norae Bang, the virtual reality device can display a virtual reality video in which only Norae Bangs are shown or highlighted in the street. Further, it is possible to provide the direction to move to Norae Bangs or the Norae Bang that the user has selected.

Further, the virtual reality device, other than finding out specific stores, can acquire and display a list of one or more stores using filters such as the kind of the store and the price range that a user is looking for in accordance with input by the user, can display the internal structure of the store that the user has selected as virtual reality, and can make a reservation at the store selected in accordance with the user input or guide the user to the selected store.

Further, the virtual reality device can communicate with a small chip that can perform near field communication or network communication. The small chip can be attached to an article and the virtual reality device can determine the location of the chip by communicating with the small chip. The virtual reality device visualizes and displays the location of the small chip on the virtual reality device. For example, even if a bag with the small chip attached thereto is in a closet, a video in which the small chip twinkles is displayed beyond the door of the closet on the virtual reality device, thereby being able to make the user know that the bag is in the closet. In an embodiment, the virtual reality device can store in advance the information about each small chip. For example, by storing the ID of each chip and the information about the article having each chip attached thereto, when a user is looking for a specific article, it is possible to provide the location of the corresponding chip to the user in various ways. For example, the virtual reality device can provide a video, which makes a user feel like seeing an article that he/she is looking for through a wall or a door, to the user using a virtual reality video.

In an embodiment, the virtual reality device can measure the distance to a point that a user looks at using a plurality of cameras. For example, the virtual reality device can measure the distance to the point that a user looks at using triangulation. Further, when the virtual reality device can acquire the information about the actual size of an object that a user looks at (e.g., the actual height of a building), the virtual reality device can calculate the distance on the basis of the difference between the actual size and the size shown in a video.

In an embodiment, the virtual reality device can provide a recipe to a user, can determine the cooking order and method of the user, the kinds of ingredients, the amounts of the ingredients, the amount of water, the intensity of fire, etc. while the user cooks, and can provide notification and necessary advices to the user when the user cooks without following the recipe.

Further, the virtual reality device recognizes a comb, a pen, a brush, a driver, and other tools or utensils that a user uses in a taken video and combines the recognized objects with a virtual reality video, thereby being able to display a virtual reality image that can assist the user to use the tools or utensils. For example, it is possible to display a guide, a use method, precautions, etc. for easy use of the tools. The guide may include paths to move tools, positions and directions in which the tools are supposed to be put.

Further, the virtual reality device can show the voice, lyrics, atmosphere, etc. of a song that a user sings, using temperature, smell, humidity, electricity, and touch controllers that operate with the virtual reality device.

Accordingly, the user can experience 4D based on music.

The virtual reality device can acquire the tones and beats of a song that the user sings and can display a comparison result by comparing the tones and beats of the user with the acquired tones and beats. The virtual reality device can display a video that corrects the wrong parts in the tones and beats of the user.

In an embodiment, the virtual reality device can recognize the sound of an animal included in a received voice and can provide the information about the animal corresponding to the recognized sound.

In an embodiment, the virtual reality device can photograph and recognize handwriting. The virtual reality device can analyze the personality or the intellectual power of the person of the handwriting. As information that is used for analysis, guide information input by a specialist and data accumulated through learning may be used.

Further, the virtual reality device can analyze the talking habit and vocabularies of a counterpart when a wearer talks with the counterpart, and can determine the personality or intellectual level of the counterpart on the basis of the analysis result.

Further, the virtual reality device can estimate and provide the grade of the vocabulary level of a user by analyzing the habit of the user using his/her mother language or a foreign language.

Further, when a user purchases or orders food or looks at specific food in a virtual store, the virtual reality device acquires the components of the food and displays the information about whether the user can eat the food on the basis of information about the physical constitution, health, and disease of the user and information input in advance such as whether the user is on a diet or has an allergy. For example, the virtual reality device can display the information that the sum of the total calories taken on the day and the calories of specific food exceeds the daily recommended calories.

Further, the virtual reality device stores the information about a product that a user purchased and the history of the store, automatically manages a discount coupon or an accumulation coupon, and provides relevant information when the user purchase a specific product again or visit the store again.

In an embodiment, an additional virtual object is given specific authority or is displayed only on a virtual reality device that is unlocked through a password, etc., whereby the additional virtual object can be used to share secrete information or keep personal privacy.

In an embodiment, the virtual reality device can provide an interpreting function. In this case, the virtual reality device can acquire the information about the voice of a user by analyzing the voiceprint of the user and can playback an interpreted language into the voice of the user using the acquired information about the voice of the user.

For example, when two users have a conversation with each other in two different languages (e.g., English and Korean), the virtual reality device can make the voice of the English user not heard or heard quietly and can make only the interpreted Korean voice heard loudly by the Korean user. Further, the virtual reality device can make the voice of the Korean user not heard or heard quiet and make only the interpreted English voice heard loudly by the English user. In this case, an earphone can be used and also can independently perform the function.

Further, the virtual reality device can show a state, which is different from the actual state of a wearer of another virtual reality device, to the wearer of the other virtual reality device. For example, even if a student wearing the virtual reality device is asleep, it is possible to display a virtual reality video as if the student is taking the lesson to a teacher wearing another virtual reality device.

In an embodiment, the virtual reality device can remove a virtual reality device from the face of a first wearer, which a second wearer of another virtual reality device sees, and can display the face of the first wearer at the removed position, by taking a picture of the face of a first wearer in real time or using a face video of the first wearer taken in advance.

For example, the virtual reality device can replace at least a portion of the face of the first wearer with the virtual reality device on with the taken face of the first wearer in the virtual reality video of another virtual reality device by transmitting the taken face image of the first wearer to a server of the another virtual reality device.

In an embodiment, the virtual reality device can automatically estimate the shape, position, and state of the other parts of the user's body not included in the camera angle, using a part of the body of the photographed user.

In an embodiment, the virtual reality device further includes at least one camera and take a picture of at least a portion of the body of a user. For example, the virtual reality device includes at least one camera facing down on the bottom, thereby taking a picture of at least a portion of the body of a user who wears the virtual reality device.

In an embodiment, the virtual reality device can request a user to scan his/her body when the user initially uses the virtual reality device. For example, when a user makes the camera of the virtual reality device face to his/her body, the virtual reality device acquires the information of the user's body by scanning the user's body. For example, the virtual reality device acquires the height and body shape of the user.

The virtual reality device can automatically estimate the shape, position, and state of the other parts of the user's body not included in the camera angle, using the acquired information about the user's body and at least a portion of the user's body photographed by at least one camera of the virtual reality device.

Accordingly, the virtual reality device can display the figure of the entire body of the user not actually photographed in a video at a third-person point of view. Further, the virtual reality device can provide more various virtual experiences to the user on the basis of the estimated body state of the user. For example, when the user plays a fighting game using the virtual reality device, it is possible to estimate an interaction to the user's body not included in the camera angle and reflect the interaction to the game.

The virtual reality device can estimate the entire body of the user not actually photographed, and can correct the form of the user in weight training, yoga, and other sports on the basis of the estimated figure of the entire body of the user. For example, it is possible to display a specific posture in a virtual realty video, and can evaluate movement of a user and propose the evaluation result when the user moves in accordance with the displayed posture.

Further, the virtual reality device can quantitatively or qualitatively collect and analyze data including the school time, the degree of concentration on study, the amount of activity, consumption of calories, the total amount of conversation with friends, the contents of conversation, the conversation time, relationship with friends, the degree of close friendship, sociability, etc. of a student, and can create and provide a corresponding report.

Further, the virtual reality device can determine the degree of fatigue of user's eyes by taking a picture of user's eyes using a camera thereof and analyzing the video of the user's eyes. The virtual reality device can determine movement, capillaries, and the degree of congestion of the user's eyes from the video of the user's eyes and can determine the degree of fatigue of the user's eyes on the basis of these factors.

Further, the virtual reality device can recognize various indexes such as yawning, brain waves, facial expressions, the pulse, and movement in addition to the eyes of the user, can determine the degree of fatigue or condition of the user corresponding to the indexes, and can provide the determination result in percent. When the condition of the user drops under a predetermined percent, the virtual reality device can request the user to take a rest like requesting charging of an electronic device.

The virtual reality device can transmit a signal of abnormality to the user by changing the image into black and white, blinking the image, etc., depending on the degree of fatigue of the user's eyes. Alternately, the virtual reality device can change the display way to make the eyes less tired, depending on the degree of fatigue of the user's eyes.

Further, the virtual reality device can recognize the degree of fatigue of the user's eyes, propose the user to stretch the eyes, and display a video for stretching eyes or massage the eyes using vibration or pressure.

Further, when the user's eyes are closed over a predetermined time, the virtual reality device can determine that the user is asleep and can automatically turn off the image. Further, when the eyes of a user who is walking are closed over a predetermined time, it is possible to determine that it is an emergency and automatically call 119. Further, the virtual reality device can sense the health condition of a user such as the pulse or breath in real time, and can automatically call 119 when determining that it is an emergency.

Further, the virtual reality device can determine an inflammation and other diseases in the body of a user and the health condition of the user by sensing the mouth smell of the user. When the virtual reality device measures periodically or non-periodically the mouth smell of a user over a predetermined period, it is possible to acquire various items of health information such as a change in health condition of the user, aging, whether the user brushes his/her teeth, the number of times of brushing, and the frequency of brushing.

Further, the virtual reality device can learn movement of the eyelids, movement of the eyeballs, movement of the pupils, etc. when a user is sleepy or tired, by recognizing movement of the user's eyes. The virtual reality device can determine the state of the user on the basis of movement of at least one of the eyelids, eyeballs, and pupils of the user in the learning result.

Further, when a user plays a game using the virtual reality device according to the disclosed embodiment, it is possible to provide virtual reality videos at arioso viewpoints using at least one camera disposed behind the user's head.

In an embodiment, the virtual reality device may not operate unless a user is spaced over a predetermined distance (e.g., 20 cm) from the image.

The virtual reality device can hypnotizes a user in a virtual image using various hypnoses and can measure the degree of concentration of the depth of hypnosis. The virtual reality device can awake a hypnotized user, depending on situations.

The virtual reality device can make record of thoughts, determination, and corresponding actions of a user into a database and can make a human clone (artificial intelligence) sharing memories with the user on the basis of the database.

When a dangerous situation (e.g., a fire, a robbery, an earthquake, a war, a disaster) occurs while a user uses the virtual reality device, the virtual reality device can change the use image into an emergency (urgent) image, or can explain the dangerous situation to the user. According to another embodiment, the virtual reality device can show an external situation at a predetermined ratio in at least a portion of a virtual reality video, can provide an overlapping function, and may not provide notification for a dangerous situation under a predetermined level, depending on the propensity of a user. For example, the virtual reality device can determine what level of dangerous situation a user considers to be important, on the basis of brain waves or the usual behavior pattern of the user. Further, the size of an image may be proportionally enlarged in accordance with the degree of ratio of pupils in the image. It is possible to additionally pop up one or more windows using a brain wave.

The virtual reality device can measure and display the life expectancy of a user. For example, it is possible to calculate the life expectancy of a user by analyzing various factors such as a life pattern including the history of regular checkup, exercise, and eating habits of the user, the pulse of the user, aging, and networks and conversations with other people.

The virtual reality device can provide titles for foreign news, movies, etc. in three steps of the original text, pronunciations of Korean or the mother language, and a subtitle of Korean and the mother language. The pronunciations of Korean or the mother language may be Korean or the mother language at the level of natives so that a user can easily repeat the pronunciations of natives. Depending on embodiments, interpretation and pronunciation may be provided at specific position in a smaller size than translation.

Further, it is possible to increase or decrease the left-right width of the shape of each character in accordance with the length of the pronunciation when showing the original text or the mother language, and it is possible to adjust the height of the characters in accordance with the tone.

When a user selects a specific part of a displayed title, the virtual reality device can provide information about what the part grammatically means, why the part is used, and what the detailed meaning of the part is, etc.

Further, the virtual reality device can provide subtitles in speech bubbles together with a video.

In an embodiment, when the user does not pronounce a foreign language well, it is possible to create a voice with accurate pronunciation and replace the user's voice with the created voice.

In an embodiment, the virtual reality device can provide vocabulary data to the user and can frequently provide words, which the user does not memorize well, in a sentence type. Further, it is possible to check what words the user has difficulty in recalling and know what parts the user feels difficult about or what parts the user is not good at by analyzing brain waves, and can provide corresponding supplementary study data.

The study data that is provided to the user may depend on the level of the user.

The virtual reality device can check the taste of the user or configure a general story and can provide re-study data by collecting only the words or contents that the user forgets during studying or using brain waves.

The virtual reality device can recognize what environment, video, or study method is good for the user to study through brain wave analysis and other result measurement. For example, the virtual reality device can analyze the power of concentration, the power of memory, the power of understanding, and the adaptability, can calculate and apply time for the user to reach a specific level through study, and can provide an optimal study environment to the user on the basis of these factors.

In an embodiment, the virtual reality device determines the degree of concentration of a user on the basis of the brain waves of the user, and can play music or video, request the user to go out, and stop paying the study contents provided from the virtual reality device when determining the power of concentration has dropped.

In an embodiment, when a user has a conversation in a real space, the virtual reality device can make and display the speech of the counterpart into an augmented reality video in which characters or words are simultaneously displayed in speech bubbles. The virtual reality device can determine the degree of understanding conversations or languages by analyzing biological reactions or word expressions in the conversations of the user and the counterpart.

Further, the virtual reality device can monitor conversations between users, can let both of them or only one user know important missing words or insufficient contents in the conversations and contexts using various signals such as a sound, a character, and a voice, and can give advice or information. Further, it is possible to combine images of the counterpart and use it for study.

In an embodiment, the virtual reality device analyzes long conversations and nuances between people, thereby being able to determine and provide whether the speech speed is high, or the counterpart jokes, ironically talks, inattentively talks, sincerely talks, contradicts, agrees, speaks favorably, etc. In this case, it is possible to additionally analyze facial expression or biological information.

In an embodiment, the virtual reality device can make stories and scenes to fit to the language subject of study or a conversation that a user intends, can adjust the level of study or words to fit to various study fields or the vocabulary ability of the user, and can adjust, change, and provide the video or the contents of study in accordance with the degree of concentration and the degree of response by analyzing a brain wave pattern and stress.

In an embodiment, a platform service that provides a virtual selling space may be provided. For example, an empty space in which virtual products can be exhibited can be created in a virtual reality space or existing empty spaces may be sold in lots by requests of users. The users can induce users who visit their virtual spaces to check and purchase corresponding articles by arranging virtual objects corresponding to products, which they sell, or arranging product introduction videos in the sold spaces.

For example, it is possible to provide a virtual reality mart and sell empty selling spaces in lots to shopping mall owners, the shopping mall owners can arrange products in the sold virtual spaces, and a user can purchase desired products while looking around the virtual reality mart.

When a minister preaches at a virtual church, the virtual reality device can collect the degrees of response of believers through a sensor. For example, it is possible to collect all kinds of biological reactions such as movement of pupils, brain waves, and voices of believers, check the degree of concentration of each of the believers, and quantify and digitize the degree of absorption in the sermon of each believer.

The virtual reality device can calculate the levels of the believers in the church by checking the praying time, worshiping time, mission work time, service time, etc. That is, it is possible to digitize the church activities of the believers into predetermined levels or ranks, and can publish them to the outside.

The virtual reality device can display the place where an acquaintance of a believer exists and the user can takes a position by the acquaintance in the virtual church. The acquaintance is still shown aside in the virtual reality device of the person who has sit next to the acquaintance, but the user is shown like sitting between the acquaintance and the person in his/her virtual reality device.

In the virtual reality device, the user can be shown like sitting in the next seat when the acquaintance has a conversation with the user and another person can be shown like sitting in the next seat when the acquaintance has a conversation with the person.

Even if users have a conversation with each other or speak over the telephone, using dialects, their virtual reality devices can convert and transmit the voices into the standard language. Further, the virtual reality device can discriminate a standard language and a dialect and can determine the hometown or the native plate of the counterpart by analyzing the way the counterpart talks.

The virtual reality device can make a user simultaneously attend several places by making human clones of a user in virtual reality or using an actual autonomous robot. For example, when there are two or more simultaneous real or virtual seminars, a user can make and simultaneously send human clones to the two seminars and can make the human clones automatically attend the seminars at a predetermined time. Further, at least one of the human clones may be controlled or not in real time by the user.

When another person talks to the robot the autonomous robot or the human clone not controlled by the user or an external stimulus is applied to the human clone, the virtual reality device can change the image for the user to control the human clone.

After the human clones finish the designated experiences, the user can have the same experiences that are performed in the virtual space like he actually attends the events through the records of the experience. For example, after a seminar is finished, the user can restart the experience like he attends the seminar in person on the basis of the record acquired by the human clone.

Depending on embodiments, it is possible to replay in the same way not the experience of the human clone, but the direct experience of the user. For example, the user can playback the same lecture for review.

When a human clone exists in a virtual space, the virtual reality device can change the image for the user to directly control the human clone when another person requests a conversation, many conversations are progressed in the surround even without a direct request for a conversation, or there is a body contact between them. The human clone may be an autonomous robot that is connected to the user and can have a camera function or an avatar graphic on an artificial intelligence brain learning the history of the user.

The virtual reality device may include a device for sending a beverage. For example, the virtual reality device can carry the main raw material of each beverage and can make a beverage with a specific taste by mixing the temperature, smell, and taste of each beverage. It is possible to include facilities, for example, for boiling a beverage, adding food colors, freezing, and refrigerating by connecting additional facilities in order to make a beverage, such a combination of beverages can be transmitted to other virtual reality devices, and users can share the beverages using the virtual reality devices.

The virtual reality device can collect information and can buy and sell a corresponding real estate. The virtual reality device, when collecting the information of a real estate, can estate the future price of each real estate by combining development information (e.g., roads, harbors, railroads, and city plan) and risk information (e.g., an earthquake, a fault, nuclear power, environment, and noise) in each area, by acquiring, combining, and learning all kinds of possible property information that can be given to each real estate such as education, traffic, and natural environment, and by learning corresponding changes in price.

The virtual reality device can set filters in accordance with setting by a user, can continuously find out a real estate corresponding to the various filters set by the user such as the taste, the environment, the structure, the interior, the price, and the traffic that the user wants, and can provide notification to the user when an article for sale that the user needs is found out.

The virtual reality device can determine that the real estate is vulnerable to an earthquake, a continuous rain, snow, and mold on the basis of the construction information of the real estate. The virtual reality device acquires the actual figure of the real estate and can provide the degree of danger in real time by recognizing images of the acquired figure. For example, it is possible to inform the user of the degree of danger in real time by determining whether the shape of a house is vulnerable to an earthquake and by checking in real time whether there are cracks in the wall, whether there are portions leaking rain, whether there is mold, which is not easily shown though, etc., through image analysis.

The virtual reality device compares a finished product model picture and an actually assembled product and displays the actually assembled product in a virtual image, but it can find out a wrong portion, a non-completed portion, and a portion with a part missing and let a user know these portions.

For example, it is possible to determine a case in which the size or the color is different from that in the blueprint or of the completed product or a case in which a sticker or a screw is omitted, and provide information.

The virtual reality device collects the information of the properties of the ground in the area where a user is positioned or actually measures the properties of the ground, thereby being able to provide a cultivation technique suitable for the properties of the ground to a user for each time or season.

Further, the virtual reality device can estimate and provide the optimal sowing time, harvesting time, watering time, etc. by estimating the sunlight, wind, humidity, etc., and can provide also the information about fertilizing, manuring, etc. The virtual reality device compares the optimal farming method and the actual farming progress, thereby being able to provide the information about the degree of coincidence or difference, and the differences to the user. When farming progresses wrong, the virtual reality device can provide the information about the optimal method in the current state to the user.

The virtual reality device can automatically perform watering, manuring, blocking the sunlight, feeding domestic animals by operating with farming machines as it is programmed in accordance with predetermined functions.

The virtual reality device can provide the information about the domestic animals that show abnormal actions (e.g., which are sick or have a problem) by keeping observing the domestic animals. Further, it is also possible to provide the information about domestic animals with lack of exercise.

The virtual reality device provides a guide for an optimal method for the livestock farming too, similar to agriculture, (e.g., the eating time, eating amount, amount of exercise of domestic animals), and compares the optimal method with an actual method, thereby being able to provide consulting information or appropriate eating, music, etc.

The virtual reality device can provide a guide service for the blind. For example, the virtual reality device can explain the surrounding environment, guide a route, read or analyze characters, or guide a route to a blind person, or let a blind person know the locations of an elevator button, or presses an elevator button instead, and can express or convert and provide all surrounding things recognized in a store or a book store into a voice.

The virtual reality device can also perform functions for the deaf and can visually display and provide a talk of another person in various ways using pictures, emoticons, texts, etc. The virtual reality device can provide the information about the surrounding situations or the nuance of speech of another person to the user by analyzing surrounding noise too.

The virtual reality device checks the gazes of other people looking at a user in all direction in a real space and determines how many people look at or have an interest in the user by photographing the surrounding, thereby being able to provide the relevant information to the user. The virtual reality device can also know how long they look at the user by determining what part of the user they look at and estimating the angle of the gaze or the virtual reality device of the user, and can provide the information about people determined as having a good feeling.

The virtual reality device can observe the degree of dryness of the eyes, the state of the eyeballs, etc. of a user, can measure a change in the eyelids of the user and the degree of aging of the user, and can provide a perspective image according to the eyesight of the user.

The virtual reality device can assist stretching of the user's eyeballs. For example, by making the user look at a specific position or point, making the point that the user looks at move closer or far in an image, and moving the point up, down, left, and right in the image, it is possible to assist the user to be able to stretch the eyeballs in various directions. Alternately, it is possible to artificially perform exercise for recovering the eyesight by enlarging and reducing the entire image, moving the entire image up, down, left, right, and diagonally, rotating and reversing the entire image, etc.

Further, the virtual reality device can assist blood circulation of the eyes or massage the eyes using a vibration device, a heating device, etc., and this service can be provided when the virtual reality device determines that the eyelids of the user close (e.g., the user dozes) or the eyes are tired by observing the eyes of the user.

The virtual reality device can adjust the environment of a real or virtual space to correspond to the contents of an article when a user reads the article. For example, when the virtual reality device recognizes a piece of writing “a peach smell in wind at a hot desert”, it is possible to increase the surrounding temperature and blow wind and it is also possible to transmit the peach smell.

When a user reads a book, the virtual reality device can change the color of the parts that the user has read by tracing the gaze of the user. Accordingly, the user can know what part of the book he/she has read up to through the virtual reality device.

The virtual reality device can recognize a text and can playback the recognized text using the voice of a user or a famous person.

In an embodiment, the virtual reality device can find out a real or virtual object and can express the name of the object in each language. For example, the virtual reality device can combine a real or virtual object at a point of view with another object, and can let a user know the meaning and name using a voice or characters.

When there is an interesting opposite sex in a crowded place such as a subway, an airplane, and a street, the virtual reality device can determine whether the opposite sex is interested in a user by checking the pulse, pupils, facial expression, etc. of the opposite sex. The virtual reality device can acquire the information about an opposite sex whom the user has interest in by checking the pulse, pupils, facial expression, etc. of the user, and can also determine whether the opposite sex whom the user has interest in has an interest in the user.

When they both have a good feeling, the virtual reality device can function as a matchmaker by automatically introduce them to each other.

The virtual reality device can show commodities to be sold in different ways in a virtual space. For example, it is possible to highlight the commodities to be sold or apply different colors to the commodities to be sold. For example, when an owner input in advance the information about products to sell of products shown or exhibited in a space such as a virtual cafe or house, the virtual reality device can check whether customers have an intention to purchase the products and can actually sell the product by showing the products to sell in different ways.

Similarly, by checking and publish articles to sold in a house, other people can check and purchase or order desired ones of the articles to sell by visiting the house like a flea market.

When a user wants to do a specific action in a virtual space, the virtual reality device can reduce unnecessary actions by completing the action by analyzing actions of the user. For example, when recognizing an action of a user starting to open a bag, the virtual reality device can immediately open the bag, and when a user puts his/her feet to shoes, the virtual reality device can immediately put the shoes on the user's feet. Similarly, when a user starts to manicure, the manicure is completely applied and dried.

When a user shops in a virtual space, the virtual reality device can float a small window like a black hole in a virtual empty space. It is possible to enlarge or reduce an image using a biological recognition system for a touch, a voice, a brain wave, and an eye, and a user can store a desired article in a depository (cart) by putting the desired article into the window through the same system and can move to another space or see another space through the window.

The virtual reality device can determine the personality of a user by generally analyzing the penmanship, voice, words, tone, talk speed, accent, breath, facial expression, movement of muscles, a gesture, a pattern, a frequency, an expression type of writing, an attitude in a virtual space, movement of the eyes of a user, etc.

The virtual reality device can determine the nail colors or bends and flow of a pattern of a user, using a camera, and can provide an advise or a warn for the health of the user.

The virtual reality device can hide touch buttons at several places in a background image. For example, a puppy displayed in a background image may be an internet application and a flow may be connected to a gallery application.

Accordingly, even if another user obtains the virtual reality device, he/she does know the hidden functions, so he/she cannot use the virtual reality device well.

The virtual reality device can take a picture of a specific position in a real space and can use the position as a marker or an electronic code. For example, a user can take a picture of a specific position and can store predetermined information in correspondence to the position. In this case, another user has to take the same picture at the same position in order to acquire stored information. Accordingly, when sharing information, it is possible to increase security by adding physical and spatial limitations according to the actual position.

Further, virtual reality devices can determine the positions of each other through communication therebetween. The virtual reality device can sense another virtual reality device showing an abnormal act. For example, when it is determined that a specific virtual reality device keep follow with a specific distance maintained, it is possible to transmit the movement of the virtual reality device to a user. Further, since there is the possibility of a stalker, it is possible to send a warning to the virtual reality device or to transmit the information about the virtual reality device or a rescue signal to an external server (police, etc.).

In an embodiment, it is possible to achieve a function of calling the users of virtual reality devices. For example, a virtual reality device can call the user of another virtual reality device under permission of the user of the other virtual reality device. In this case, the users of the two virtual reality devices are displayed in the counter virtual reality images, respectively.

As another example, there may be ranks between the users of different virtual reality devices. For example, a parent can call a child without permission.

In an embodiment, the calling function may be used as an inviting function. For example, a user invites another user to the virtual reality device displayed by his/her virtual reality device, whereby even though they are actually in different spaces, they can watch a virtual reality video of the same virtual reality space in the same virtual reality space.

The inviting user and the invited user can have a conversation or can interact with each other while looking at the actual figures of each other or characters (or avatars) of each other.

A virtual reality device can share the locations of each other if there is permission of the counterpart, or when different virtual reality devices approach each other over a predetermine speed, it is possible to analyze and provide their locations, movement speeds, and dangerousness to the users. This may be used for safe traffic and may not be used in public transportation.

In an embodiment, the virtual reality device can give a specific theme or skin to a surrounding video. For example, when giving a horror concept theme to a normal street video, the virtual reality device can display a video with ghosts walking around and ruined buildings. Further, it is possible to display a combination video that makes a sterile street shown like a street with flowers, and it is possible to combination videos with various themes to a user by combining skins with various concepts selected by the user with a real video. Further, it is possible to enable a user to play a game using game elements displayed in a video of a real space that the user took, by adding a game function.

In an embodiment, the virtual reality device can differently process videos in accordance with the range of the visual field. For example, it is possible to assume that there are a first visual field range that a user can look at and a second visual field range that is in the visual field of the user but the user does not look at. Since the visual field range of people may be different, the second visual field range can include even a predetermined range out of the user's visual field.

In an embodiment, the virtual reality device can determine the distances between objects in a video on the basis of the gaze of a user looking at the video for shapes in a visual field image, and can adjust the pixels such that objects positioned close are shown clear and objects positioned far are shown unclear in accordance with the determination result.

In this case, the virtual reality device can display a virtual reality video in the first visual field range such that movement and rendering are sufficient performed, and can display a virtual reality video in the second visual field range such that movement or rendering in the image decreases generally or differently away from the visual field.

In this case, it is possible to considerably reduce the load on a memory and a system, but processing according to a change of the gaze of the user should be naturally performed so that the user can appreciate the virtual reality video naturally without a sense of incongruity.

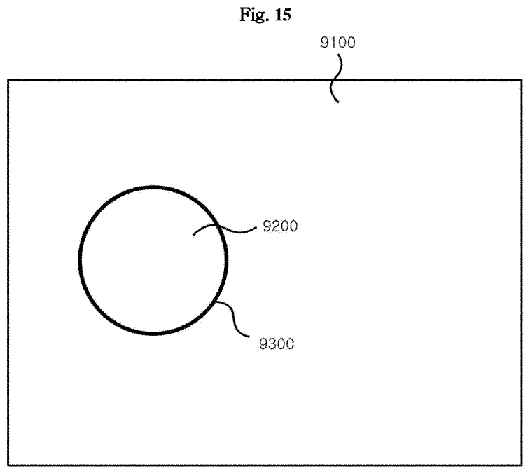

FIG. 15 is a view showing a method of combining an object and a background in accordance with an embodiment.

In an embodiment, it is possible to create a virtual reality video by combining a background 9100 and an object 9200 that are different from each other.

In the background 9100 and the object 9200, the light sources are different from each other, the perspective according to a distance is different, the density and shade are respectively different, and the reference sizes are different, so a sense of difference can be shown from the object combined with the background.

Accordingly, the virtual reality device can naturally combine the background 9100 and the object 9200 without a sense of difference therebetween by automatically adjusting the density, shade, direction of light, the position and length of a shadow, etc. in the background 9100 and the object 9200.

In an embodiment, when the object 9200 is added to the background 9100, the virtual reality device can naturally combine the object 9200 in the background 9100 without a sense of difference by automatically adjusting the density, shade, direction of light, the position and length of a shadow, etc. in the object 9200 with respect to the background 9100.

Further, the virtual reality device can render the combined image such that the surrounding environment, which changes in accordance with the sunlight, light, a shadow, and time including day and night, for each theme by converting the real video including the background 9100 and the object 9200 into a digital video.

Further, the virtual reality device can naturally combine the background 9100 and the object 9200 by blurring the boundary 9300 between the combined background 9100 and object 9200 to make the boundary dim like a fog, or by adjusting the color of the boundary to hide the boundary 9300.

Further, the virtual reality device can perform an out-focusing function that display the object clear and blurs the background 9100 except for the object 9200 in the virtual reality video.

In order to reduce a sense of difference between a virtual video and a real video when combining the virtual video and the real video, the virtual reality device can fit the pixels, density, etc. of the real video to those of the virtual video (background) or can correct the virtual video and the real video at a predetermined ratios to show similar feelings.

When a user introduces the structure of a house such as rooms or a dining room to another person, the virtual reality video can combine a predetermined video with the real video and provide it to the visitor in consideration of the image that the visitor sees on the basis of the location of the visitor.

The virtual reality video can measure the eyesight of the user and can provide an image having pixels, density, and an aspect ratio that fit to the measure eyesight to the user.

The virtual reality video can be divided and provided into left and right videos. The virtual reality video can be provided differently on the basis of the eyesight of the left eye and the right eye or the feature of the visual field of the user.

The virtual reality device can enlarge or reduce and provide the size of characters or the video in accordance with the eyesight of the user.

When constructing a virtual space, the virtual reality device can create a video that is naturally shown like reality even though it is a virtual space, by combining some detailed portions with the real image. For example, by not only rendering all regions in 3D, but also mixing the real video, it is possible to make the user recognize the video as a real video without feeling a sense of difference.

The virtual reality device can display the real image in a part of the video when the user eats between meals or needs to use a real object while watching the virtual video. For example, it is possible to insert and display a video with a snack at a corner in a small size, and when the user stretches a hand to the snack, it is possible to enlarge the video with the snack so that the user can easily hold the snack.

In an embodiment, the virtual reality device can calculate the singing scores of people in various ways. For example, it is possible to reflect not only the beat and the tone, but also dancing to evaluation.

In an embodiment, the virtual reality device can perform vocal training using the voice of a user or another voice.

In an embodiment, the virtual reality device can instruct a user in beat, tone, and technique.

In an embodiment, the virtual reality device can analyze the taste of a user, compose music, compose partial music, and write lyrics, can sing a famous song of a famous singer using another voice, and can select a favorite voice color of the user.

In an embodiment, when a user thinks of a tone and lyrics, the virtual reality device can sing a song instead using a voice cooler of the user accompanied by a brain wave or another voice color and can set a suitable accompaniment to fit to the taste of the user.

In an embodiment, the virtual reality device can order a wet tissue, liquor or beverage, water, a side dish, etc. while the user uses an entertainment place such as a Norae Bang by analyzing brain waves.

In an embodiment, the virtual reality device can slight change the voice color of the user to fit to the song and the atmosphere.

In an embodiment, the virtual reality device can analyze the tastes and the degrees of response of other people in a Norae Bang, it is a Norae Bang, on the basis of biological information independently or in cooperation with the system in the entertainment place.

In an embodiment, the virtual reality device can adjust the brightness or colors of lights to fit to a brain wave or the atmosphere of the user or an intention.

In an embodiment, when a scene of a vibration sound that is generated by a real speaker, etc. is displayed in a virtual video, the virtual reality device can separately apply this function to the Norae Bang system and can apply the video to the image so that a real vibration effect can be generated.

In an embodiment, the virtual reality device can generate a smell from a Norae Bang system in accordance with the atmosphere, a user's intention, or the lyrics.

In an embodiment, the virtual reality device recognize an initial face or voice coming through a device in an artificial intelligence order system, thereby being able to recognize it as the subject of an order (i.e., a master), react only the master's voice without obeying others' orders. In this case, a voice, a tone, and an image can be slightly changed within the same range.

In an embodiment, when recognizing death of the master, the virtual reality device can destroy programs or stop operation by itself.

In an embodiment, a user can express like entering a real space except for the real body at a distance using the virtual reality device. In an embodiment, the virtual reality device can recognize movement of the user and can adjust the direction of a video in accordance with the direction of the user moving in a specific space. Further, as the user moves in a specific direction, the virtual reality device can recognize the speed of the user going in the specific direction on the basis of the movement speed and steps of the user, and accordingly, can increase or decrease the size of a video in the direction. For example, a plurality of cameras is disposed in a real specific space to enter, and the cameras operating with the virtual reality device determines the location, movement direction, speed, and gaze of a user in another area. The virtual reality device that moves with the cameras and recognizes movement provides images taken by the cameras to the user to fit to the location, movement direction, speed, and gaze of the user while zooming in or out the images taken and changing the direction. In an embodiment, the cameras operate with the virtual reality device and can connect, delete, or combine overlapping parts of images or videos taken by the cameras. In an embodiment, the virtual reality device and the cameras can enlarge and reduce an image for each distance and can apply a start line in various ways in consideration of the acting time of the user. In an embodiment, at least one drone can be used together with the cameras. The drone moves to follow a user at various locations such as a virtual eye of the user, or over, behind, and ahead of the user's head. When the user turns the head or moves the gaze, the drone should be positioned in symmetric opposite direction such that the drone is not shown in the visual field and can take a picture in the direction that the user looks at. The drone moves at the same speed as the user and the cameras operates with the gaze of the user.

In an embodiment, when a user enters a real store and designates a an article to purchase by looking at the article or using a voice order, a brain, or the biological recognition method described above, the virtual reality device can pay for the article so that the user can purchase the article.

In an embodiment, even though the user shops in a real store, the virtual reality device can move the point of view to another space through a camera in the store, can move a commodity, and can provide analysis information. Further, when an article put into a cart is sensed through an attached sensor, the virtual reality device can pay the price of all articles without separately paying for the article at a counter, thereby being able to enable the user to keep enjoying shopping. Further, the user can know the price when putting an article into the cart and can cancel purchase for some commodity without putting back the commodities where they were. Further, the virtual reality device can provide the information about each commodity by operating with a sensor attached to the cart, and to this end, the virtual reality device can have at least one sensor for virtual reality.

In an embodiment, the virtual reality device can make the gaze of a virtual character or an object to face a user when the user enters a virtual space. Further, even if the user walk in place, the user can be displayed like walking forward or rearward at the same speed in the virtual space.

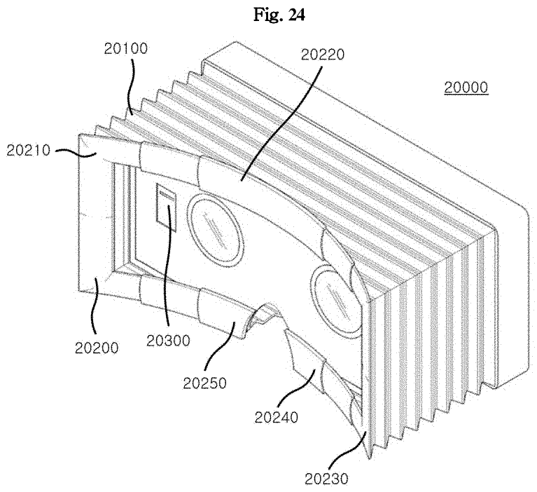

FIG. 24 is a view showing a virtual reality device according to an embodiment.

Referring to FIG. 24, a virtual reality device 20000 is shown. As described above, the virtual reality device 20000 may be formed in a case structure that accommodates a user's terminal and may be a device for virtual reality which includes its own display.

In an embodiment, the virtual reality device 20000 includes a foldable screen barrel 20100. In an embodiment, the screen barrel 20100 may be a bellows but is not limited thereto.

In an embodiment, a vent 20300 for a rear camera may be formed at an ocular plate of the virtual reality device 20000. The vent 20300 is used to expose a rear camera of a user's terminal, which is accommodated in the virtual reality device 20000, to the outside or is used to take a picture of the user's face or back.

In an embodiment, the vent 20300 can be opened/closed in a sliding type, but the opening/closing type is not limited.

In an embodiment, the virtual reality device 20000 further includes a contact portion 20200 that can come in contact with the face of a user. In an embodiment, the contact portion 20200 is composed of one or more divided parts 20210 to 20250, and each of the parts are accommodated into each other when the virtual reality device 20000 is folded such that the contact portion 202000 can be stowed in a flat state.

Further, when the virtual reality device 20000 is unfolded, the parts slide out of each other to be unfolded in a curved shape to fit to the face of a user.

In an embodiment, only some 20210, 20220, 20230, 20240, and 20250 of the parts may be combined with the screen barrel 20100 to be able to slide in and out of each other, and the other may be configured to slide without being coupled, but the coupling way and the detailed coupling positions of the parts and the screen barrel 20100 are not limited thereto. For example, a locking step may be formed on a side in each of the parts to prevent separation of the parts, and the parts combined with the screen barrel 20100 may be combined only in some area of the entire area.

The steps of the method or algorithm described in relation to the embodiment in the present disclosure may be directly implemented by hardware, software that is executed by hardware, or a combination thereof. As software module may be permanently stationed on a RAM (Random Access Memory), a ROM (Read Only Memory), an EPROM (Erasable Programmable ROM), an EEPROM (Electrically Erasable Programmable ROM), a flash memory, a hard disk, a detachable disk, a CD-ROM, or a certain type of computer-readable recording medium well known in the art.

### INDUSTRIAL APPLICABILITY

The present disclosure provides a foldable virtual reality device that can be easily carried and allows virtual reality or augmented reality to be implemented right at a desired time and place.

In detail, the present disclosure provides a cell phone case that includes a virtual reality function.

1-7. (canceled)

8. A foldable virtual reality device, comprising:
a casing configured to separably accommodate a main body including a display; and
a switching body rotatably attached to a side of the casing, switching to come in close contact with a front surface or a rear surface of the main body, and including a screen member and an ocular plate mounted on the screen member,
wherein the screen member moves the ocular plate between a state in which the ocular plate is in close contact with the display and a state in which the ocular plate is spaced a predetermined distance from the display, in a state in which the screen member is in close contact with a surface of the main body on which the display is formed, and
when the ocular plate is spaced, a virtual reality function can be implemented through the display.

9. The foldable virtual reality device of claim 8, wherein the switching body is rotatably mounted on a long side or a short side of the main body.

10. A foldable virtual reality device, comprising: a switching body slidably mounted on guide rails of a main body that includes a display and the rail guide formed in parallel along a side, switching to come in close contact with a front surface and a rear surface of the main body, and including a screen member and an ocular plate mounted on the screen member,
wherein the screen member moves the ocular plate between a state in which the ocular plate is in close contact with the display and a state in which the ocular plate is spaced a predetermined distance from the display, in a state in which the screen member is in close contact with a surface of the main body on which the display is formed, and
when the ocular plate is spaced, a virtual reality function can be implemented through the display.

11. The foldable virtual reality device of claim 10, wherein the guide rails are formed along a long side or a short slide of the main body.

12. The foldable virtual reality device of claim 10, wherein the switching body switches to the front surface or the rear surface of the main body and can be mounted back on the main body after separated from the main body.

13. A foldable virtual reality device, comprising: a switching body switching to come in close contact with a front surface and a rear surface of a main body that includes a display, and including an ocular plate mounted on the screen member,
wherein the switching body can slide and rotate with respect to the main body, thereby being able to switch between the front surface and the rear surface of the main body,
the screen member moves the ocular plate between a state in which the ocular plate is in close contact with the display and a state in which the ocular plate is spaced a predetermined distance from the display, in a state in which the screen member is in close contact with a surface of the main body on which the display is formed, and
when the ocular plate is spaced, a virtual reality function can be implemented through the display.

14. The foldable virtual reality device of claim 13, further comprising:
a rail body mounted rotatably with respect to the main body and coupling the switching body such that the switching body can slide,
wherein the rail body is mounted on a long side or a short side of the main body.
